(19) United States
(12) Patent Application Publication
(10) Pub. No.: US 2023/0246359 A1
(43) Pub. Date: Aug. 3, 2023

(54) CONNECTOR, CONNECTOR DEVICE, AND METHOD FOR MANUFACTURING CONNECTOR

(71) Applicant: I-PEX Inc., Kyoto-shi (JP)

(72) Inventor: Sho SUZUKI, Tokyo (JP)

(21) Appl. No.: 18/299,776

(22) Filed: Apr. 13, 2023

Related U.S. Application Data
(63) Continuation of application No. PCT/JP2021/038064, filed on Oct. 14, 2021.

(30) Foreign Application Priority Data
Oct. 16, 2020 (JP) 2020-174554

(51) Int. Cl. H01R 12/71; H01R 13/6594; H01R 13/6582; H01R 43/00

(52) U.S. Cl. CPC H01R 12/716; H01R 13/6582; H01R 13/6594; H01R 43/00

(57) ABSTRACT

A connector includes a plurality of contacts respectively connected to a plurality of conductors of a board, an insulating housing, and a shell formed by drawing compound and electrically connected to a ground conductor of the board, wherein the plurality of contacts include one or more first type contacts, and one or more second type contacts for transmitting high frequency signals having a higher frequency than signals transmitted by the first type contacts, and wherein the shell includes a side portion that seamlessly surrounds an outer periphery of the housing, a ground connection portion that is integrally provided with the side portion and extends outwards from the side portion to be connected to the board, and a shield wall portion that partitions the housing into a first type holding area that holds the first type contacts and a second type holding area that holds the second type contacts.

### CROSS-REFERENCE TO RELATED APPLICATIONS

This application is a continuation application of PCT Application No. PCT/JP2021/038064, filed on Oct. 14, 2021, which claims the benefit of priority from Japanese Patent Application No. 2020-174554, filed on Oct. 16, 2020. The entire contents of the above listed PCT and priority applications are incorporated herein by reference.

### BACKGROUND

The present disclosure relates to a connector, a connector device, and a method for manufacturing a connector.

Japanese Unexamined Patent Publication No. 2020-102462 discloses an electrical connector set having an external grounding member that is circumferentially closed so as to surround an exterior of a high-frequency signal connection terminal when seen in an insertion and removal direction. The external grounding member electromagnetically shields the high-frequency signal connection terminal.

Additional noise suppression is desired in the electrical connector set such as that exemplified in Japanese Unexamined Patent Publication No. 2020-102462. For example, when a member for surrounding and electromagnetically shielding a signal connection terminal of a connector is manufactured by conventional bending operation, a seam is inevitably formed in the member. Since leakage of noise occurs from such a seam, electromagnetic interference (EMI) characteristics of a connector may deteriorate. Therefore, the present disclosure provides a connector, a connector device, and a method for manufacturing a connector capable of improving the EMI characteristics.

### SUMMARY

A connector according to one aspect of the present disclosure is a connector fitted to a mating connector, including a plurality of contacts respectively connected to a plurality of conductors of a board, an insulating housing holding the plurality of contacts, and a shell formed by drawing compound and electrically connected to a ground conductor of the board, wherein the plurality of contacts include one or more first type contacts, and one or more second type contacts for transmitting high frequency signals having a higher frequency than signals transmitted by the first type contacts, and wherein the shell includes a side portion that seamlessly surrounds an outer periphery of the housing, a ground connection portion that is integrally provided with the side portion and extends outwards from the side portion to be connected to the board, and a shield wall portion that partitions the housing into a first type holding area that holds the first type contacts and a second type holding area that holds the second type contacts.

In the connector according to one aspect of the present disclosure, the shell mounted on the housing is formed by drawing compound. In such a shell, the side portion that surrounds the outer periphery of the housing may seamlessly surround the outer periphery of the housing, and also the ground connection portion connected to the board is formed to extend outwards from the side portion. According to such a configuration, since the portion from the board to the side portion of the shell is sealed, leakage of noise from the inside of the shell to the outside is curbed. Moreover, in the connector, the housing is partitioned into the first type holding area that holds the first type contacts and the second type holding area that holds the second type contacts for high frequency signals by the shield wall portion of the shell. Mutual influence of noise between the first type contact and the second type contact may be reduced by isolating the second type contact, which tends to be a noise source and is susceptible to noise, from the first type contact. With such a configuration, the EMI characteristics of the connector may be improved.

A connector device according to one aspect of the present disclosure is a connector device which includes a plug connector and a receptacle connector fitted to the plug connector, wherein the receptacle connector includes a plurality of contacts respectively connected to a plurality of conductors of a board, an insulating housing holding the plurality of contacts, and a shell formed by drawing compound and electrically connected to a ground conductor of the board, wherein the plurality of contacts include one or more first type contacts, and one or more second type contacts for transmitting high frequency signals having a higher frequency than signals transmitted by the first type contacts, the shell has a side portion that seamlessly surrounds an outer periphery of the housing, a ground connection portion that is integrally provided with the side portion and extends outwards from the side portion to be connected to the board, and a receptacle shield wall portion that partitions the housing into a first type holding area that holds the first type contacts and a second type holding area that holds the second type contacts, and wherein the plug connector includes a conductive plug shield wall portion adjacent to the receptacle shield wall portion in a state in which the plug connector and the receptacle connector are fitted to each other.

In the connector device according to one aspect of the present disclosure, the shell mounted on the housing is formed by drawing compound. In such a shell, the side portion that surrounds the outer periphery of the housing may seamlessly surround the outer periphery of the housing, and also the ground connection portion connected to the board is formed to extend outwards from the side portion. According to such a configuration, since the portion from the board to the side portion of the shell is sealed, leakage of noise from the inside of the shell to the outside is curbed. Further, in the connector device, the housing is partitioned into the first type holding area that holds the first type contacts and the second type holding area that holds the second type contacts for high frequency signals by the receptacle shield wall portion of the shell. Mutual influence of noise between the first type contact and the second type contact may be reduced by isolating the second type contact, which tends to be a noise source and is susceptible to noise, from the first type contact. Also, in a state in which the plug connector and the receptacle connector are fitted to each other, the receptacle shield wall portion and the plug shield wall portion jointly partition the first type holding area 1 and the second type holding area. Therefore, mutual influence of noise between the first type contact and the second type contact may be reduced. Thus, the EMI characteristics of the connector device 1 may be improved.

A method for manufacturing a connector according to one aspect of the present disclosure is a method for manufacturing a connector, including performing drawing compound on a metal plate to form a side portion, a ground connection portion and an upper surface seamlessly, wherein the ground connection portion extends integrally from a lower end portion of the side portion outwards so as to face a board, and wherein the upper surface extends integrally from an upper end portion of the side portion and extends parallel to the ground connection portion, preparing an insulating housing and a plurality of contacts, wherein the plurality of contacts are assembled in the housing and include one or more first type contacts and one or more second type contacts, and wherein the one or more second type contacts are configured to transmit high frequency signals having a higher frequency than signals transmitted by the first type contacts, cutting out the upper surface such that opening portions are formed at positions corresponding to the plurality of contacts when the upper surface is seen from a vertical direction, so as to form a shield wall member and a coupling portion, wherein the coupling portion connects the side portion to the shield wall member integrally, bending the shield wall member in a fitting direction of the connector and a mating connector so as to form a shield wall portion, wherein a shell of the connector includes the side portion, the ground connection portion, the shield wall portion and the coupling portion, and mounting the housing in the shell so as to partition the housing into a first type holding area and a second type holding area by the shield wall portion.

In the manufacturing method for a connector according to one aspect of the present disclosure, first, the metal plate is drawn to form the side portion, the ground connection portion, and the upper surface. Second, the plurality of contacts (including the first type contacts and the second type contacts for high-frequency signals) assembled in the insulating housing are prepared. Third, when the upper surface formed by drawing compound is seen from the vertical direction, the coupling portion connected to the side portion and the shield wall member connected to the coupling portion are formed by cutting out the upper surface such that the opening portions are formed at positions corresponding to the plurality of contacts. Fourth, the shield wall portion is formed by bending the shield wall member in the fitting direction of the connector and the mating connector. The shell that forms the connector is manufactured by the operations so far. Fifth, when the housing is mounted in the shell, the connector in which the housing is partitioned into the first type holding area and the second type holding area by the shield wall portion is manufactured. According to such a manufacturing method, the side portion for seamlessly surrounding the outer periphery of the housing that forms the connector, the ground connection portion that is continuous with the side portion, and the upper surface are formed all at once. In addition, since the coupling portion connected to the side portion and the shield wall member serving as the shield wall portion are formed by a remaining portion from which the upper surface is cut out, each member of the shell is manufactured of the same metal plate. Thus, the rigidity of the shell is improved, and the number of parts is reduced, resulting in a simple configuration. In the connector manufactured by the manufacturing method, the shell mounted on the housing is formed by drawing compound. In such a shell, the side portion surrounding the outer periphery of the housing may seamlessly surround the outer periphery of the housing, and also the ground connection portion connected to the board is formed to extend outwards from the side portion. According to such a configuration, since the portion from the board to the side portion of the shell is sealed, leakage of noise from the inside of the shell to the outside is curbed. Further, in the connector, the housing is partitioned into the first type holding area that holds the first type contacts and the second type holding area that holds the second type contacts for high-frequency signals by the shield wall portion of the shell. In this way, mutual influence of noise between the first type contact and the second type contact may be reduced by isolating the second type contact, which tends to be a noise source and is susceptible to noise, from the first type contact. With such a configuration, the EMI characteristics of the connector may be improved.

According to the present disclosure, it is possible to provide a connector, a connector device, and a method for manufacturing a connector capable of improving EMI characteristics.

### BRIEF DESCRIPTION OF THE DRAWINGS

FIG. 1 is an example of a connector device showing a state before each connector is fitted.

FIGS. 2A to 2D are diagrams showing an example of a receptacle connector. FIG. 2A is a plan view, FIG. 2B is a bottom view, FIG. 2C is a perspective view, and FIG. 2D is a perspective view from another direction.

FIG. 3 is a perspective view showing an example of a housing that holds a plurality of contacts.

FIGS. 4A to 4D are diagrams showing an example of a shell. FIG. 4A is a plan view, FIG. 4B is a bottom view, FIG. 4C is a perspective view, and FIG. 4D is a perspective view from another direction.

FIGS. 5A to 5D are diagrams showing an example of a plug connector. FIG. 5A is a plan view, FIG. 5B is a bottom view, FIG. 5C is a perspective view, and FIG. 5D is a perspective view from another direction.

FIG. 6 is a perspective view showing an example of a housing that holds a plurality of contacts of the plug connector.

FIGS. 7A to 7D are diagrams showing an example of a shell. FIG. 7A is a plan view, FIG. 7B is a bottom view, FIG. 7C is a perspective view, and FIG. 7D is a perspective view from another direction.

FIGS. 8A and 8B are diagrams showing an example of a connector device. FIG. 8A is a plan view, and FIG. 8B is a cross-sectional view along line A-A in FIG. 8A.

FIGS. 9A to 9C are diagrams showing an example of a connector device. FIG. 9A is a plan view, FIG. 9B is a cross-sectional view along line B-B in FIG. 9A, and FIG. 9C is a cross-sectional view showing a cross section along line C-C in FIG. 9A.

FIG. 10 is a diagram showing a manufacturing operation of a receptacle connector.

FIG. 11 is a diagram showing the manufacturing operation of the receptacle connector.

FIG. 12 is a diagram showing the manufacturing operation of the receptacle connector.

FIG. 13 is a diagram showing the manufacturing operation of the receptacle connector.

FIG. 14 is a diagram showing the manufacturing operation of the receptacle connector.

FIGS. 15A to 15D are diagrams showing a modified example of the shell of the receptacle connector. FIG. 15A is a plan view, FIG. 15B is a bottom view, FIG. 15C is a perspective view, and FIG. 15D is a perspective view from another direction.

FIGS. 16A to 16C are diagrams showing an example of a plug connector according to a modified example. FIG. 16A is a plan view, FIG. 16B is a bottom view, and FIG. 16C is a perspective view.

FIGS. 17A to 17C are views showing an example of a plug contact and a plug shell according to a modified example. FIG. 17A is a plan view, FIG. 17B is a bottom view, and FIG. 17C is a perspective view.

FIGS. 18A to 18C are diagrams showing an example of a receptacle connector according to a modified example. FIG. 18A is a plan view, FIG. 18B is a bottom view, and FIG. 18C is a perspective view.

FIGS. 19A to 19C are diagrams showing an example of a receptacle contact and a receptacle shell according to a modified example. FIG. 19A is a plan view, FIG. 19B is a bottom view, and FIG. 19C is a perspective view.

### DETAILED DESCRIPTION

In the following description, with reference to the drawings, the same reference numbers are assigned to the same components or to similar components having the same function, and overlapping description is omitted.

### Connector Device

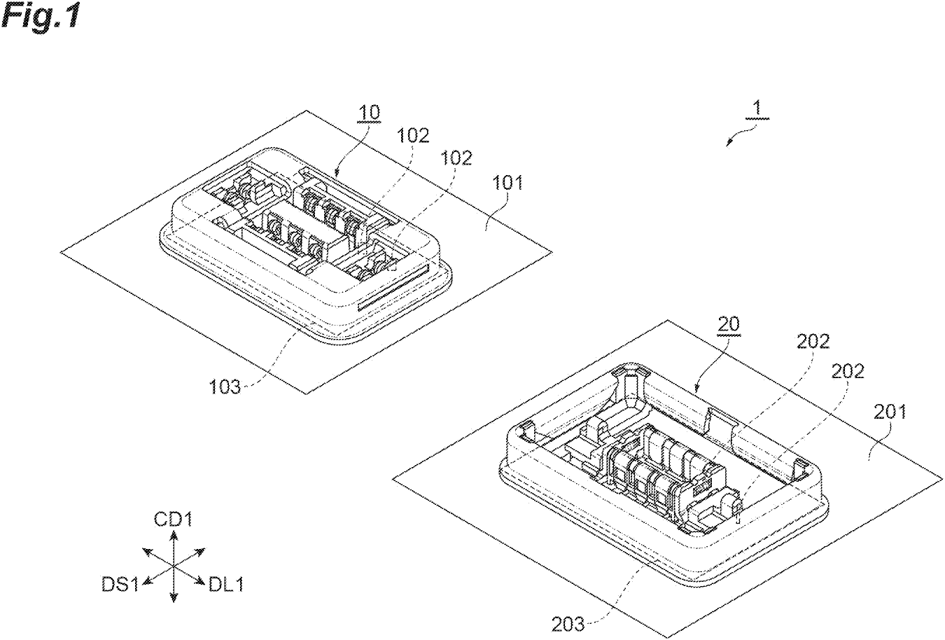

A connector device 1 shown in FIG. 1 is a device used for connecting circuit boards in an electronic device. Specific examples of the electronic device include portable communication terminals such as mobile phones, smartphones, laptop computers, and tablet computers, but are not limited thereto.

As shown in FIG. 1, the connector device 1 includes a receptacle connector 10 and a plug connector 20 that are mounted on each of two circuit boards 101 and 201. A plurality of conductors 102 (conductors that form a part of a signal circuit) and ground conductors 103 (conductors that form a part of a ground circuit) are formed on the board 101. A plurality of conductors 202 (conductors that form a part of a signal circuit) and ground conductors 203 (conductors that form a part of a ground circuit) are formed on the board 201. The connector device 1 electrically connects the conductors on the two boards 101 and 201 by fitting the receptacle connector 10 and the plug connector 20 to each other. In FIG. 1, the plug connector 20 is shown upside down in a vertical direction which is a fitting direction.

In a state in which the receptacle connector 10 and the plug connector 20 are fitted to each other, both a shape of the plug connector 20 seen from the receptacle connector 10 and a shape of the receptacle connector 10 seen from the plug connector 20 approximate a rectangle. Hereinafter, a direction along a long side of the rectangle will be referred to as a long side direction DL1, and a direction along a short side of the rectangle will be referred to as a short side direction DS1. A direction perpendicular to the rectangle is called a connection direction CD1 (or a fitting direction) of the receptacle connector 10 and the plug connector 20. Hereinafter, in the state in which the receptacle connector 10 and the plug connector 20 are fitted to each other, when a structure of the plug connector 20 seen from the receptacle connector 10 is described, it is simply referred to as “seen from the receptacle connector 10”, and when a structure of the receptacle connector 10 seen from the plug connector 20 is described, it is simply referred to as “seen from the plug connector 20.”

### Receptacle Connector

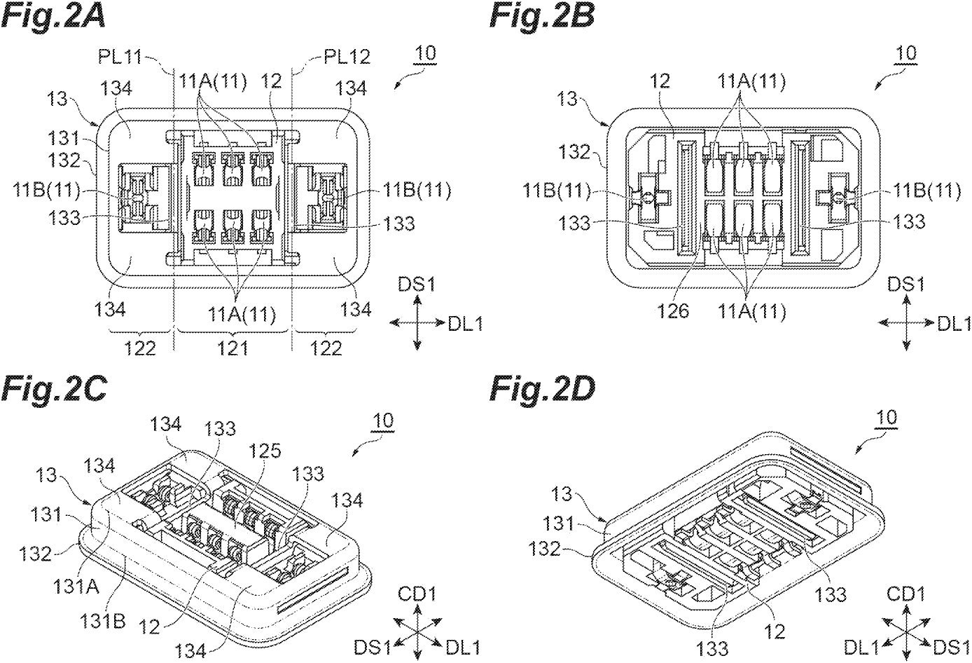

First, a configuration of the receptacle connector 10 will be described in detail. The receptacle connector 10 is mounted on a board 101 and connected to the plug connector 20 as a mating connector. As shown in FIGS. 2A to 2D, the receptacle connector 10 has a plurality of conductive contacts 11, a housing 12 as a contact holding part, and a shell 13.

The plurality of contacts 11 are conductive members that are respectively connected to a plurality of conductors 102 (for example, signal conductors) of the board 101. In the state in which the plug connector 20 and the receptacle connector 10 are fitted, the plurality of contacts 11 make contact with the plurality of contacts 21 (described below) of the plug connector 20 sandwiched therebetween.

The plurality of contacts 11 may include contacts 11 of different types. For example, the plurality of contacts 11 includes one or more first type contacts 11A and one or more second type contacts 11B of a type different from the first type contacts 11A. As an example, the plurality of contacts 11 include six first type contacts 11A and two second type contacts 11B. For example, the two second type contacts 11B may be disposed at both ends in the long side direction DL1, and the six first type contacts 11A may be disposed so as to be sandwiched between the two second type contacts 11B. As for the six first type contacts 11A, three pairs of first type contacts 11A facing each other in the short side direction DS1 are disposed in the long side direction DL1.

“Different types” means that they belong to mutually different types under a certain definition that identifies a difference in type. Specific examples of the difference in type include a difference in frequency band of signals to be transmitted, a difference in allowable current, a difference in allowable voltage, and a difference between whether being for connecting a signal conductor (a conductor that forms a part of a signal circuit) or for connecting a ground conductor (a conductor that forms a part of a ground circuit). As an example, the second type contact 11B is a contact for transmitting a high frequency signal having a higher frequency than that of a signal transmitted by the first type contact 11A.

FIG. 2B is a bottom view of the receptacle connector 10. The first type contacts 11A are provided in the receptacle connector 10 in the short side direction DS1 so as to be connected to the conductors 102 of the board 101. The second type contacts 11B are provided at both ends in the receptacle connector 10 in the long side direction DL1 so as to be connected to the conductors 102 of the board 101. Each of the first type contacts 11A may have any shape as long as it may be mounted on the board 101 and may have a shape that does not protrude outward.

FIG. 2C is a perspective view of the receptacle connector 10. The first type contacts 11A have a pair of protrusion shapes so as to sandwich a first type contact 21A (described below) of the plug connector 20 and come into contact therewith. Each of the first type contacts 11A protrudes toward the plug connector 20 in the connection direction CD1. The second type contacts 11B have a pair of protrusion shapes so as to sandwich a second type contact 21B (described below) of the plug connector 20 and come into contact therewith. Each of the second type contacts 11B protrudes toward the plug connector 20 in the connection direction CD1.

The first type contact 11A is formed by punching out one plate material from a metal plate and bending the plate material. In the first type contact 11A, a connection portion with the board 101 and a contact portion with the first type contact 21A are connected to each other. In the second type contact 11B, a connection portion with the board 101 and a contact portion with the second type contact 21B are connected to each other.

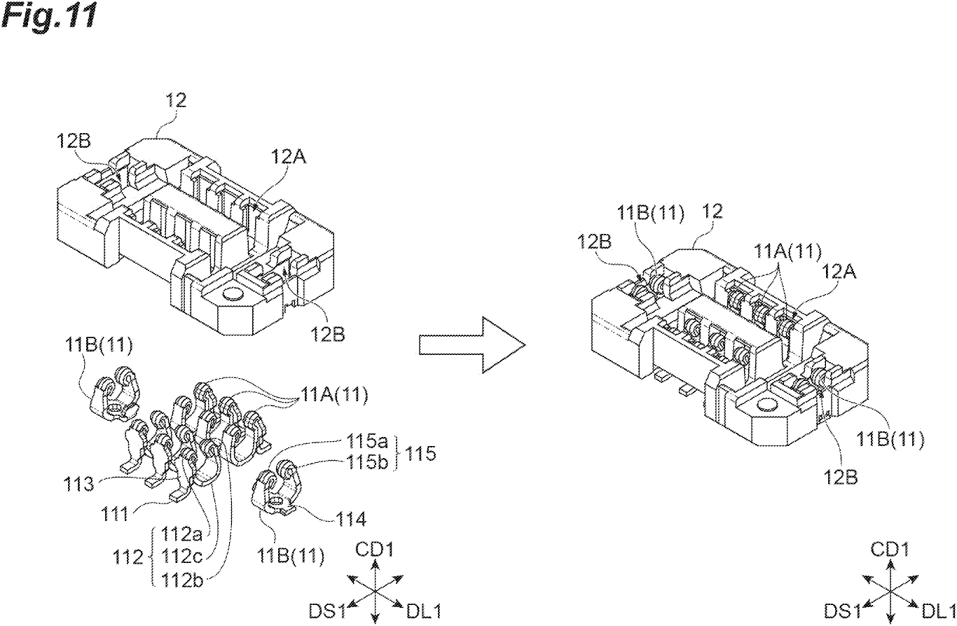

More specifically, as shown in FIG. 11, the first type contact 11A has a connection portion 111, a contact portion 112, and a coupling portion 113. The connection portion 111 extends in the short side direction DS1 and is connected to a conductor (for example, a signal conductor) of the board 101. The contact portion 112 comes into contact with the first type contact 21A (described below) of the plug connector 20. The connection portion 111 and the contact portion 112 are connected to each other by the coupling portion 113. The coupling portion 113 connects the connection portion 111 to a base portion (an upper end) of the contact portion 112.

The contact portion 112 has a first portion 112a, a second portion 112b, and a coupling portion 112c. The first portion 112a and the second portion 112b each protrude toward the plug connector 20 in the connection direction CD1 and sandwich the first type contact 21A of the plug connector 20 therebetween. The first portion 112a and the second portion 112b extend in the connection direction CD1 so as to face each other in the short side direction DS1. The coupling portion 112c connects a base portion (a lower end) of the first portion 112a to a base portion (a lower end) of the second portion 112b.

Further, the second type contact 11B has a connection portion 114 and a contact portion 115, as shown in FIG. 11. The connection portion 114 extends in the long side direction DL1 and is connected to a conductor (for example, a signal conductor) of the board 101. The contact portion 115 comes into contact with the second type contact 21B (described below) of the plug connector 20. The contact portion 115 has a first portion 115a and a second portion 115b. The first portion 115a and the second portion 115b are continuous with both side surfaces of the connection portion 114, protrude toward the plug connector 20 in the connection direction CD1, and sandwich the second type contact 21B of the plug connector 20 therebetween. The first portion 115a and the second portion 115b extend in the connection direction CD1 so as to face each other in the short side direction.

The housing 12 is an insulating member that holds the plurality of contacts 11. The housing 12 is formed by, for example, injection molding of a resin material. The housing 12 has a rear surface 126 facing the board 101 and a front surface 125 opposite to the rear surface 126 (refer to FIGS. 2B and 2C). The front surface 125 faces the plug connector 20. The housing 12 has an exterior that approximates a rectangle when seen from the plug connector 20. The housing 12 has a pair of long sides in the long side direction DL1 and a pair of short sides in the short side direction DS1.

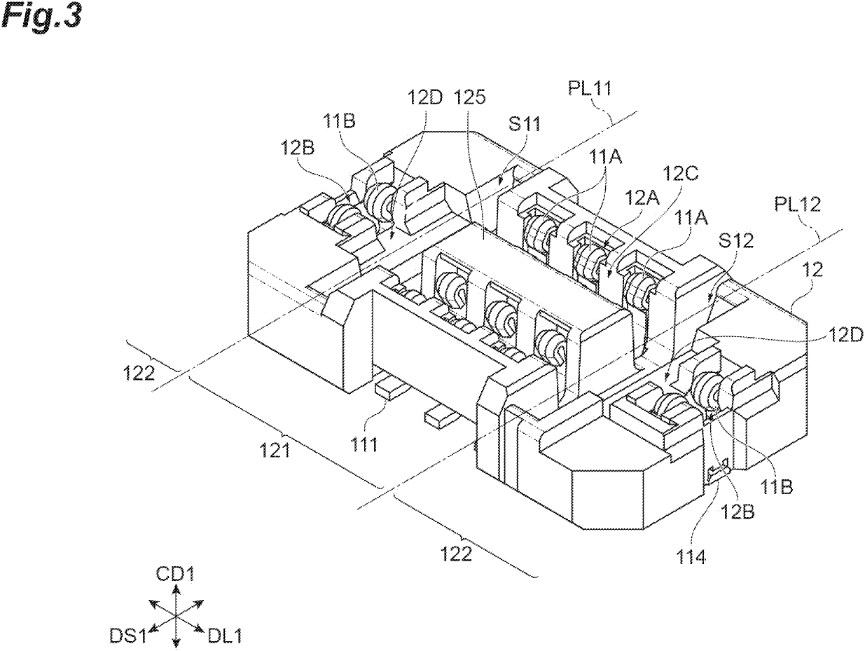

As shown in FIG. 3, the housing 12 is partitioned into a plurality of holding areas in a direction perpendicular to the connection direction CD1. The plurality of holding areas include, for example, one first type holding area 121 and two second type holding areas 122. The first type holding area 121 holds one or more (for example, six) first type contacts 11A. In the following description, it is assumed that the first type holding area 121 holds six first type contacts 11A. The second type holding area 122 holds one or more second type contacts 11B. In the following description, each of the second type holding areas 122 holds one second type contact 11B.

For example, both ends of the housing 12 in the long side direction DL1 are partitioned into two second type holding areas 122, and a region sandwiched between the two second type holding areas 122 is defined as the first type holding area 121. That is, the housing 12 is partitioned into the second type holding area 122, the first type holding area 121, and the second type holding area 122 in this order in the long side direction DL1. Hereinafter, the two second type holding areas 122 may be collectively referred to as the second type holding area 122.

The plurality of holding areas may be partitioned by gaps such as slits formed in the housing 12. For example, the second type holding area 122 and the first type holding area 121 are partitioned by a boundary PL 11 perpendicular to the long side direction DL1 and a gap SL1 along the connection direction CD1. Also, for example, the first type holding area 121 and the second type holding area 122 are partitioned by a boundary PL12 perpendicular to the long side direction DL1 and a gap S12 along the connection direction CD1.

Here, the gap means a gap when the housing 12 is present alone. That is, the gap here includes a portion that is filled with another member different from the housing 12 in a state in which the receptacle connector 10 is completed. For example, at least a part of the gaps S11 and S12 is filled with a shield wall portion 133 which will be described below.

In the housing 12, all of the plurality of contacts 11 are disposed such that directions of contact with the plurality of contacts 21 are in the same direction when seen from the plug connector 20. When seen from the plug connector 20, all the contacts 11 are disposed inside an outer edge of the housing 12 (an edge portion having the maximum dimension in the long side direction DL1 and the short side direction DS1).

The housing 12 has a first type contact accommodating portion 12A, a second type contact accommodating portion 12B, an accommodation groove portion 12C, and an accommodation groove portion 12D.

The first type contact accommodating portion 12A is a plurality of recesses (holes) provided in a surface of the first type holding area 121 that faces the board 101. The first type contact accommodating portions 12A are formed in positions corresponding to the first type contacts 11A, i.e., corresponding to the number (that is, six) of the first type contacts 11A, and accommodate the first type contacts 11A. The first type contacts 11A are accommodated in the first type contact accommodating portion 12A so as to be exposed when seen from the plug connector 20. The first type contact 11A is fixed to the first type contact accommodating portion 12A by press fitting or the like.

The second type contact accommodating portion 12B is a recess (a hole) provided in each of surfaces of a pair of second type holding areas 122 that face the board 101. The second type contact accommodating portion 12B is formed at a position corresponding to the second type contact 11B and accommodates the second type contact 11B. The second type contact 11B is accommodated in the second type contact accommodating portion 12B so as to be exposed when seen from the plug connector 20. The second type contact 11B is fixed to the second type contact accommodating portion 12B by press fitting or the like.

The accommodation groove portion 12C is one or more grooves provided in the surface of the first type holding area 121 that faces the plug connector 20. The accommodation groove portion 12C receives a holding ridge portion 22A (described below) of the housing 22 for holding the first type contact 21A of the plug connector 20.

The accommodation groove portion 12D is one or more grooves provided in the surface of the second type holding area 122 that faces the plug connector 20. The accommodation groove portion 12D receives a holding ridge portion 22B (described below) of the housing 22 for holding the second type contact 21B of the plug connector 20.

The second type contact 11B held by one second type holding area 122 is adjacent to the first type contact 11A held by the first type holding area 121 via the boundary PL11. The second type contact 11B held by the other second type holding area 122 is adjacent to the first type contact 11A of the first type holding area 121 via the boundary PL 12. Thus, a distance in the long side direction DL1 between the first type contact 11A and the second type contact 11B that are adjacent to each other via the boundaries PL11 and PL12 is larger than a distance between the first type contacts 11A adjacent to each other in the long side direction DL1 in the first type holding area 121.

A side surface of housing 12 may be straight or may be recessed. For example, the housing 12 may have a recessed portion formed in the center of the side surface in the long side direction DL1. The recessed portion in the long side direction DL1 may be formed from a surface facing the plug connector 20 to a surface facing the board 101. In the present example, when seen from the plug connector 20, the portion (the connection portion 111) that protrudes in the short side direction DS1 to be connected from the first type contact 11A to the board 101 is exposed from the recessed portion of the housing 12 in the long side direction DL1. Further, the housing 12 has a recessed portion formed in the center of the side surface in the short side direction DS1. The recessed portion in the short side direction DS1 may be formed from the surface facing the plug connector 20 to the surface facing the board 101. In the present example, when seen from the plug connector 20, the portion (the connection portion 114) that protrudes in the long side direction DL1 to be connected from the second type contact 11B to the board 101 is exposed from the recessed portion of the housing 12 in the short side direction DS1. Thus, it is possible to visually confirm a connection state (a mounting state) of the first type contacts 11A and the second type contacts 11B with respect to the board 101.

Returning to FIGS. 2A to 2D, the shell 13 is a member formed by drawing compound and electrically connected to the ground conductor 102 of the board 101. The shell 13 has a side portion 131 that seamlessly surrounds an outer periphery of the housing 12, a ground connection portion 132 that is provided integrally with the side portion 131 and extends outwards from the side portion 131 and is connected to the board 101, a shield wall portion 133 (a receptacle shield wall portion) that partitions the housing 12 into the first type holding area 121 that holds the first type contacts 11A and the second type holding area 122 that holds the second type contacts 11B.

The shell 13 encloses a region of approximately rectangular outline when seen from the plug connector 20. The rectangle has a pair of long sides in the long side direction DL1 and a pair of short sides along the short side direction DS1. The shell 13 is mounted on the housing 12 such that the side portion 131 surrounds the outer periphery of the housing 12.

The shell 13 is integrally provided with the side portion 131 that is a side surface portion and the ground connection portion 132 that is a flange portion, in a rectangular container-shaped member formed by performing drawing compound (for example, rectangular tube drawing compound) on a metal plate. Since the shell 13 is formed by drawing compound, no seams are formed on the side portion 131. Also, as shown in FIG. 2C, the ground connection portion 132 is provided continuously with a lower end portion 131B that is an end portion of the side portion 131 in a direction toward the board 101, surrounds the side portion 131 and extends outwards from the side portion 131 integrally and is connected to a ground conductor 103 formed on the board 101. Thus, the shell 13 is sealed from the board 101 to the side portion 131. Each of members of the shell 13 formed in this way is electrically connected. A plurality of conductors 102 also formed on the board 101 are surrounded by forming the ground conductors 103 formed on the board 101 in a substantially circumferential shape. Accordingly, the EMI characteristics of the entire board 101 may be further improved after the receptacle connector 10 is mounted.

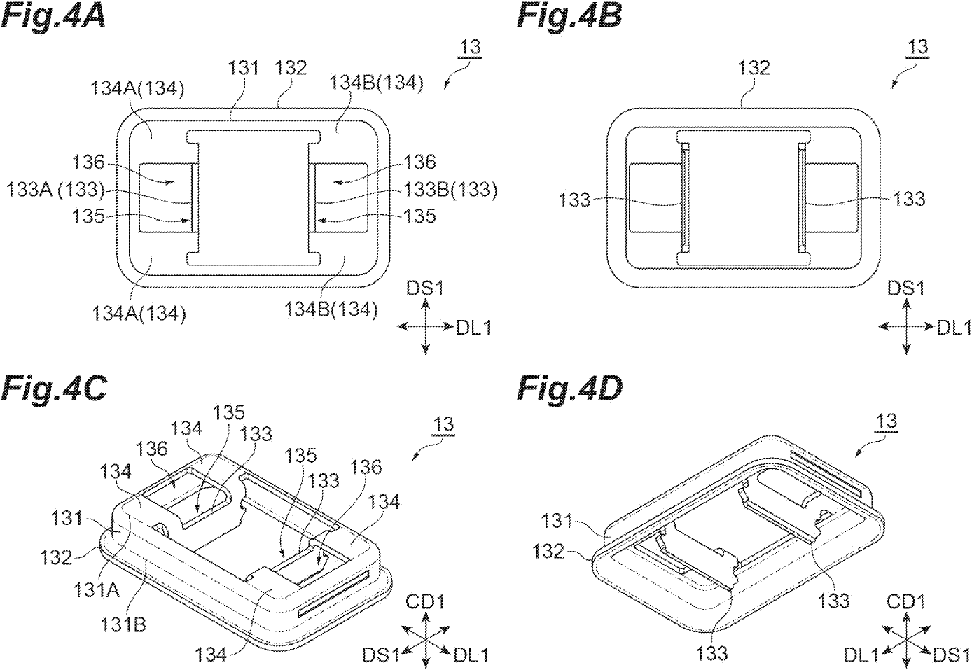

FIGS. 4A to 4D are diagrams showing an example of the shell 13. The shell 13 has two shield wall portions 133A and 133B (a first shield wall portion and a second shield wall portion) as the shield wall portions 133 that partition the housing 12 into a plurality of holding areas. The shield wall portions 133A and 133B are electrically connected to the ground conductor 103 of the board 101. The shield wall portions 133A and 133B may be directly connected to the ground conductor 103 of the board 101, or may be connected to the ground conductor 103 of the board 101 via another portion of the shell 13. In the following description, it is assumed that the shield wall portions 133A and 133B are directly connected to the ground conductor 103 of the board 101. The shield wall portions 133 extend in a planar shape.

One shield wall portion 133A is provided at a position at which one second type holding area 122 and the first type holding area 121 are partitioned in the housing 12. The other shield wall portion 133B is provided at a position at which the other second type holding area 122 and the first type holding area 121 are partitioned in the housing 12. Each of the shield wall portions 133A and 133B extends in the connection direction CD1, and one end portion (an upper end portion) is continuous with the coupling portion 113 which will be described below, and the other end portion (a lower end portion) is connected to the ground conductor 103 of the board 101. The shield wall portion 133A is located within the gap S11 (refer to FIG. 3) formed in the housing 12 such that the second type holding area 122 and the first type holding area 121 are partitioned from each other. The shield wall portion 133B is located within the gap S12 (refer to FIG. 3) formed in the housing 12 such that the first type holding area 121 and the second type holding area 122 are partitioned from each other.

The shell 13 further has a coupling portion 134 that connects the side portion 131 to the shield wall portion 133. The coupling portion 134 is provided so as to correspond to each of the two second type holding areas 122. For example, the shell 13 has two coupling portions 134A and 134B (a first coupling portion and a second coupling portion). The coupling portion 134A connects the side portion 131 and the shield wall portion 133A to each other. The coupling portion 134B connects the side portion 131 and the shield wall portion 133B to each other.

As shown in FIG. 4C, the coupling portions 134A and 134B are integrated continuously with an upper end portion 131A, which is an end portion of the side portion 131 in a direction away from the board 101, in the vertical direction that is the fitting direction with the plug connector 20, extend from the upper end portion 131A of the side portion 131, and connect the side portion 131 to the shield wall portion 133 integrally. The coupling portions 134A and 134B extend parallel to the board 101 from the upper end portion 131A toward an edge (an upper end portion) of the shield wall portion 133.

As shown in FIG. 4C, the coupling portions 134A and 134B extend from the upper end portion 131A of the side portion 131 to partially cover the second type holding area 122. To partially cover means that a part of the second type holding area 122 is hidden by the coupling portion 134 when seen from the plug connector 20 (refer to FIG. 2A).

The side portion 131 surrounds the outer periphery of the housing 12 to have a substantially quadrilateral shape when seen in the vertical direction, and the coupling portions 134 are integrated continuously at the four corners of the side portion 131 and both of two mutually intersecting sides forming the side portion 131. As shown in FIG. 2A, the side portion 131 has an exterior that approximates a rectangle, for example. As shown in FIGS. 4A and 4C, the coupling portion 134A has a portion (a first corner portion) of the side portion 131 provided continuously to both the upper end portion 131A of one side extending in the long side direction DL1 and the upper end portion 131A of one side extending in the short side direction DS1 and connected to the upper end portion of the shield wall portion 133A, and a portion (a second corner portion) of the side portion 131 provided continuously to both the upper end portion 131A of the other side extending in the long side direction DL1 and the upper end portion 131A of one side extending in the short side direction DS1 and connected to the upper end portion of the shield wall portion 133A. Further, the coupling portion 134B has a portion (a third corner portion) provided continuously to both the upper end portion 131A of one side extending in the long side direction DL1 of the side portion 131 and the upper end portion 131A of the other side extending in the short side direction DS1 and connected to the upper end portion of the shield wall portion 133B, and a portion (a fourth corner portion) provided continuously to both the upper end portion 131A of the other side extending in the long side direction DL1 and the upper end portion 131A of the other side extending in the short side direction DS1 of the side portion 131 and connected to the upper end portion of the shield wall portion 133A.

As shown in FIGS. 4A and 4C, an opening 136 for exposing the second type contact 11B is formed in the coupling portion 134. To expose the second type contacts 11B means to make the second type contacts 11B visible when seen from the plug connector 20.

As shown in FIGS. 4A and 4(c), a cutout portion 135 is formed on the shield wall portion 133 facing the opening 136. The cutout portion 135 is a portion that receives the housing 22 (described below) of the plug connector 20 in a state in which the receptacle connector 10 and the plug connector 20 are fitted to each other. In addition, the cutout portion 135 may increase the ease of bending when the shield wall portion 133 is formed by bending operation.

The above configuration is merely an example, and may be changed as appropriate. For example, the housing 12 may have at least one second type holding area 122 and may not necessarily have two or more second type holding areas 122. The housing 12 may be partitioned into four or more holding areas. The second type holding areas 122 may be adjacent to each other without the first type holding area 121 interposed between the two second type holding areas 122. Even in such a case, the two shield wall portions 133A and 133B may be doubly interposed between the second type holding areas 122.

### Plug Connector

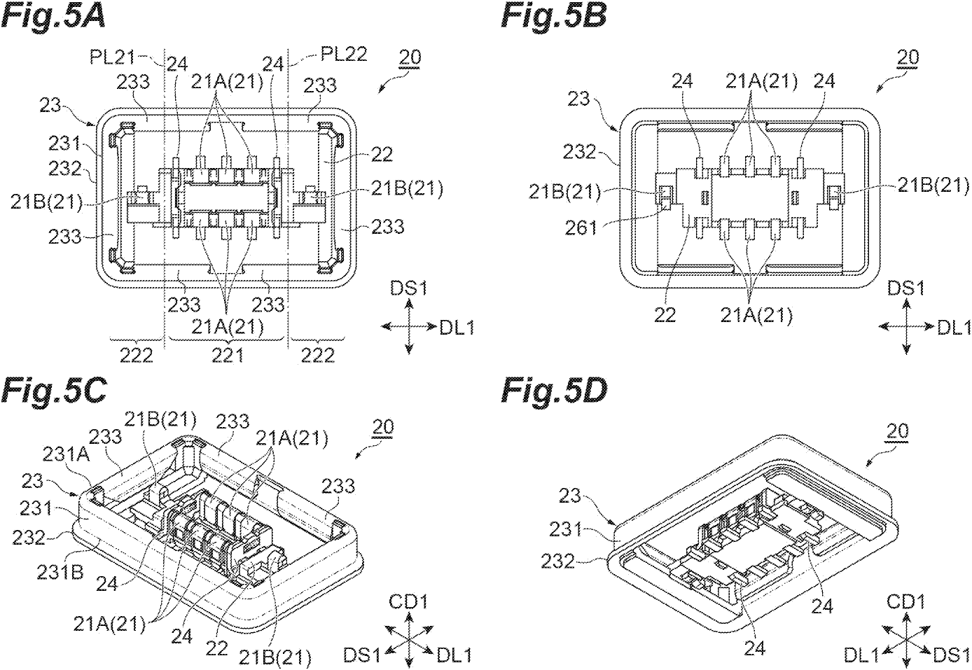

Next, the configuration of the plug connector 20 will be described in detail. The plug connector 20 is mounted on the board 201 and connected to the receptacle connector 10 as a mating connector. As shown in FIGS. 5A to 5D, the plug connector 20 includes the plurality of contacts 21, the housing 22, the shell 23, and the shield wall portion 24 (the plug shield wall portion).

The plurality of contacts 21 are conductive members that are respectively connected to the plurality of conductors 202 (for example, signal conductors) of the board 201. In the state in which the plug connector 20 and the receptacle connector 10 are fitted to each other, the plurality of contacts 21 come into contact with the plurality of contacts 11 of the receptacle connector 10 to be are sandwiched therebetween.

The plurality of contacts 21 may have contacts 21 of different types. For example, the plurality of contacts 21 include one or more first type contacts 21A and one or more second type contacts 21B of types different from the first type contacts 21A. As an example, the plurality of contacts 21 include six first type contacts 21A and two second type contacts 21B. In the long side direction DL1, for example, two second type contacts 21B may be disposed at both ends, and six first type contacts 21A may be disposed to be sandwiched between the two second type contacts 21B. As for the six first type contacts 21A, three pairs of first type contacts 21A that face each other in the short side direction DS1 are disposed in the long side direction DL1. As an example, each of the second type contacts 21B is a contact for transmitting a high frequency signal having a higher frequency than that of a signal transmitted by each of the first type contacts 21A.

FIG. 5B is a bottom view of the plug connector 20. The first type contacts 21A are provided in the plug connector 20 in the short side direction DS1 to be connected to the conductors 202 of the board 201. The second type contacts 21B are provided at both ends in the plug connector 20 in the short side direction DS1 to be connected to the conductors 202 of the board 201. The first type contacts 21A may have any shape as long as it may be mounted to the board 201, and may have a shape that does not protrude outward.

FIG. 5C is a perspective view of the plug connector 20. Each of the first type contacts 21A protrudes toward the receptacle connector 10 in the connection direction CD1 to be sandwiched between the first type contacts 11A of the receptacle connector 10. Each of the second type contacts 21B protrudes toward the receptacle connector 10 in the connection direction CD1 to be sandwiched between the second type contacts 11B of the receptacle connector 10.

The first type contact 21A is formed by punching out a plate material from a metal plate and bending the plate material. In the first type contact 21A, a connection portion with the board 201 and a contact portion with the first type contact 11A are connected to each other. In the second type contact 21B, a connection portion with the board 201 and a contact portion with the second type contact 11B are connected to each other.

The housing 22 is an insulating member that holds the plurality of contacts 21 and the shield wall portion 24. The housing 22 is formed by insert molding of a resin material, for example, in a state in which the plurality of contacts 21 are disposed. The housing 22 has a pair of long sides in the long side direction DL1 and a pair of short sides in the short side direction DS1. The housing 22 has a surface facing the board 201 and a surface facing the receptacle connector 10 in the connection direction CD1.

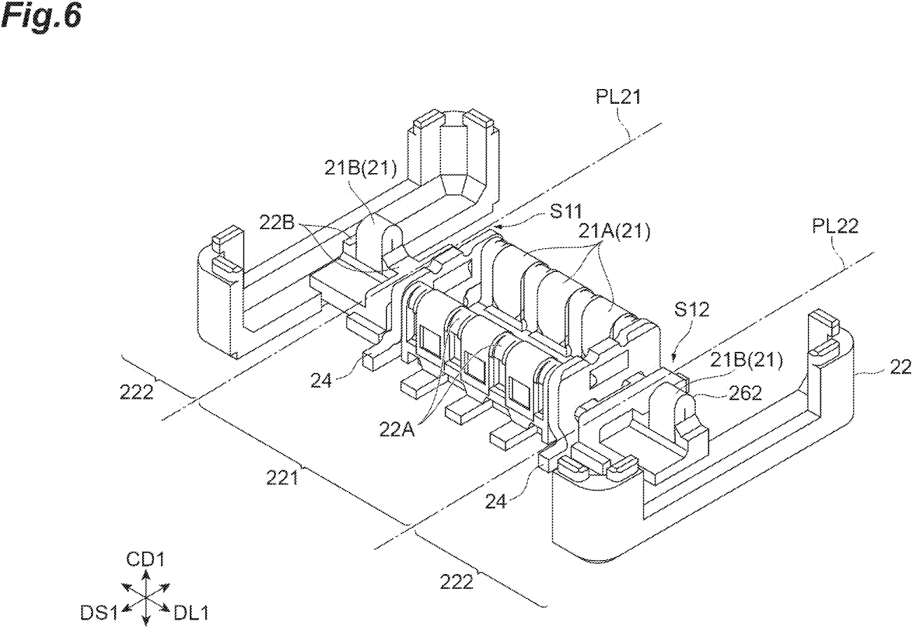

As shown in FIG. 6, the housing 22 is partitioned into a plurality of holding areas in the direction perpendicular to the connection direction CD1. The plurality of holding areas include, for example, one first type holding area 221 and two second type holding areas 222. The first type holding area 221 holds one or more (for example, six) first type contacts 21A. In the following description, it is assumed that the first type holding area 221 holds six first type contacts 21A. Each of the second type holding areas 222 holds one or more second type contacts 21B. In the following description, each of the second type holding areas 222 holds one second type contact 21B.

For example, the housing 22 is partitioned into two second type holding areas 222 at both ends in the long side direction DL1, and an area sandwiched between the two second type holding areas 222 may be partitioned as the first type holding area 221. That is, the housing 22 is partitioned into the second type holding area 222, the first type holding area 221, and the second type holding area 222 in this order in the long side direction DL1. Hereinafter, the two second type holding areas 222 may be collectively referred to as the second type holding area 222.

The plurality of holding areas may be partitioned by the shield wall portions 24 extending in the connection direction CD1. The housing 22 may be held such that the plurality of shield wall portions 24 are perpendicular to the long side direction DL1. The first type holding area 221 and the second type holding area 222 are partitioned by arranging the shield wall portions 24 in the long side direction DL1.

The plurality of holding areas may be partitioned by gaps. For example, the second type holding area 222 and the first type holding area 221 may be partitioned by a boundary PL21 perpendicular to the long side direction DL1 and the gap S12 in the connection direction CD1. Further, for example, the first type holding area 221 and the second type holding area 222 may be partitioned by a boundary PL22 perpendicular to the long side direction DL1 and the gap S12 in the connection direction CD1. The boundary PL21 and boundary PL22 correspond to the boundary PL11 and the boundary PL12, respectively, in the state in which the plug connector 20 and the receptacle connector 10 are fitted to each other. As for the gap here, at least a part in the connection direction CD1 may be a gap.

In the housing 22, all of the plurality of contacts 21 are disposed such that the directions of contact with the plurality of contacts 11 are in the same direction when seen from the receptacle connector 10. When seen from the receptacle connector 10, all the contacts 21 are disposed inward of an outer edge of the housing 22 (an edge portion having the maximum dimension in the long side direction DL1 and the short side direction DS 1).

Both the first type holding area 221 and the second type holding area 222 have holding ridge portions that protrude from a body portion toward the receptacle connector 10 in the same direction (for example, the long side direction DL1). The holding ridge portions are ridges on housing 22 for holding the plurality of contacts 21. All the contacts 21 are exposed on side surfaces of the holding ridge portions in both the first type holding area 221 and the second type holding area 222. The holding ridge portion 22A of the first type holding area 221 is accommodated in the accommodation groove portion 12C of the receptacle connector 10. The holding ridge portion 22B of the second type holding area 222 is accommodated in the accommodation groove portion 12D of the receptacle connector 10.

The first type contacts 21A pass through the first type holding area 221 from the surface facing the receptacle connector 10 toward the surface facing the board 201 and are mounted on the holding ridge portion 22A to be exposed on the side surface of the holding ridge portion 22A. The second type contacts 21B pass through the second type holding area 222 from the surface facing the receptacle connector 10 toward the surface facing the board 201 and are mounted on the holding ridge portion 22B to be exposed on the side surface of the holding ridge portion 22B.

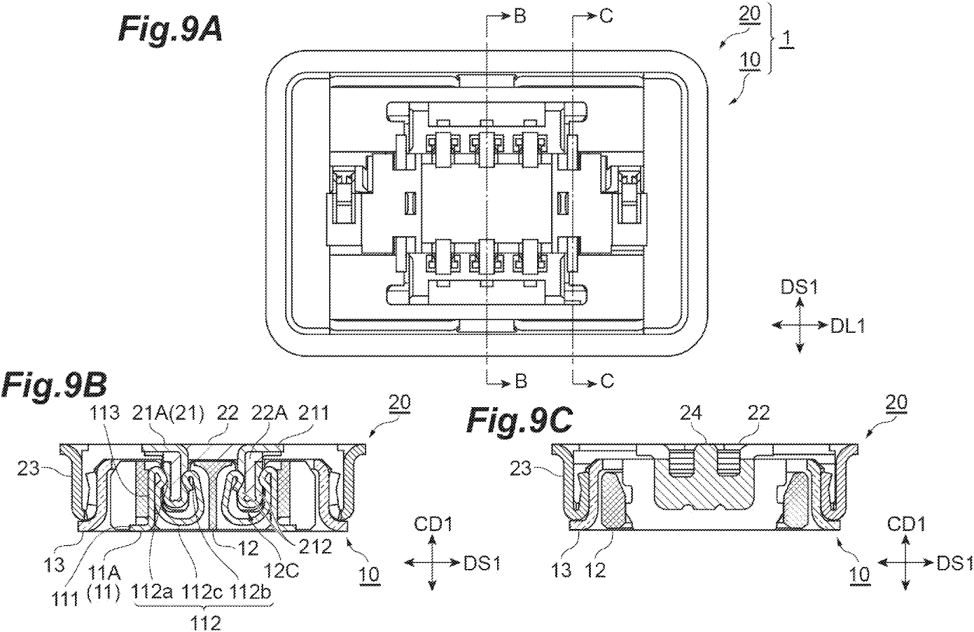

The first type contact 21A has a connection portion 211 and a contact portion 212 as shown in FIG. 9B. The contact portion 212 is sandwiched between a first portion 112a and a second portion 112b provided in the contact portion 112 of the first type contact 11A. The second type contact 21B has a connection portion 261 shown in FIG. 5B and a contact portion 262 shown in FIG. 6. The contact portion 262 is sandwiched between a first portion 112a and a second portion 112b provided in the contact portion 112 of the second type contact 11B.

The housing 22 holds six first type contacts 21A in the first type holding area 221. The housing 22 also holds two second type contacts 21B in the second type holding area 222. The second type contact 21B held by the second type holding area 222 is adjacent to the first type contact 21A held by the first type holding area 221 via the boundary PL21. The second type contact 21B held by the second type holding area 222 is adjacent to the first type contact 21A of the first type holding area 221 via the boundary PL22. Thus, a distance in the long side direction DL1 between the first type contact 21A and the second type contact 21B that are adjacent to each other via the boundaries PL21 and PL22 is larger than a distance between the first type contacts 21A adjacent to each other in the long side direction DL1 in the first type holding area 221.

When seen from the receptacle connector 10, the first type contacts 21A held by the first type holding area 221 are exposed from the housing 22 in the short side direction DS1. Also, when seen from the receptacle connector 10, the second type contacts 21B held by the second type holding area 222 are exposed from the housing 22 in the short side direction DS1. As a result, it is possible to visually confirm the connection state (the mounting state) of the first type contacts 21A and the second type contacts 21B to the board 201.

Returning to FIGS. 5A to 5D, the shell 23 is a member formed by drawing compound and electrically connected to the ground conductor 203 of the board 201. The shell 23 has a side portion 231 that seamlessly surrounds the outer periphery of the housing 22, a ground connection portion 232 provided integrally with the side portion 231, extending outwards from the side portion 231 and connected to the board 201, and an elastic body 233 provided integrally with the side portion 231 and formed to be bent toward an inner peripheral surface of the side portion 231.

The shell 23 is integrally provided with the side portion 231 that is a side surface portion and the ground connection portion 232 that is a flange portion, in a rectangular container-shaped member formed by performing drawing compound (for example, rectangular tube drawing compound) on a metal plate. Since the shell 23 is formed by drawing compound, no seams are formed on the side portions 231. Further, as shown in FIG. 5C, the ground connection portion 232 is integrated continuously with a lower end portion 231B that is an end portion of the side portion 231 in the direction toward the board 201, extends outwards from the side portion 231 and is connected to the board 201. Thus, the shell 23 is sealed from the board 201 to the side portion 231. Each of members of the shell 23 formed in this way is electrically connected. A plurality of conductors 202 also formed on the board 201 are surrounded by forming the ground conductors 203 formed on the board 201 in a substantially circumferential shape. Accordingly, the EMI characteristics of the entire board 201 may be further improved after the plug connector 20 is mounted.

The shell 23 encloses a region having an approximately rectangular outline when seen from receptacle connector 10. The rectangle has a pair of long sides in the long side direction DL1 and a pair of short sides in the short side direction DS1. The shell 23 is mounted on the housing 22 such that the side portion 231 surrounds housing 22.

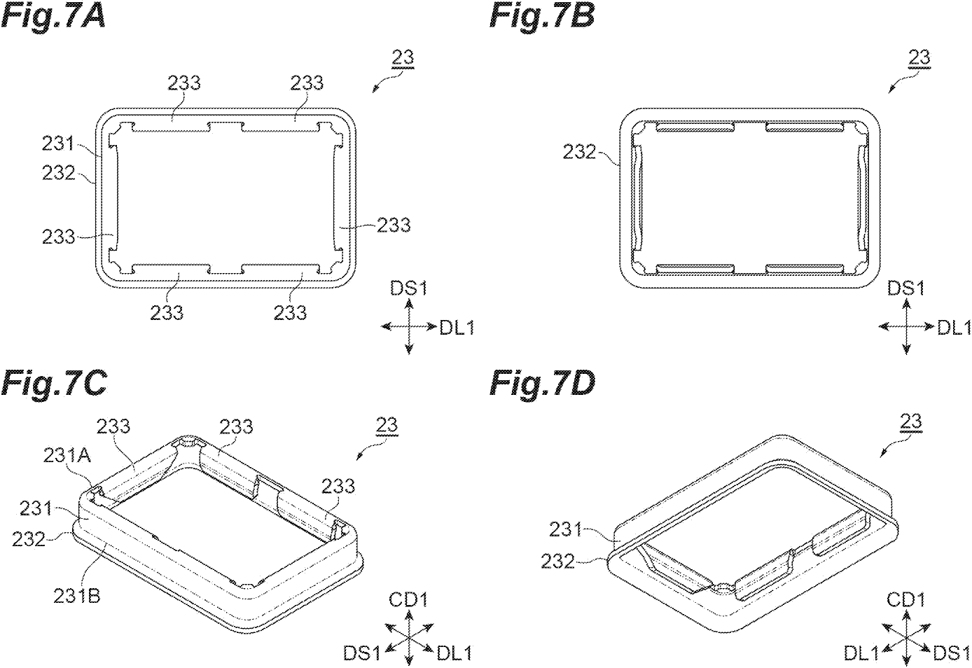

FIGS. 7A to 7D are diagrams showing an example of the shell 23. As shown in FIG. 7C, the elastic body 233 is integrated continuously with an upper end portion 231A, which is an end portion of the side portion 231 in the direction away from the board 201, in the vertical direction that is the fitting direction with the receptacle connector 10. The elastic body 233 is bent toward the inner peripheral surface of the side portion 231 with the upper end portion 231A as a base end, extends in the connection direction CD1, and is formed such that a tip end thereof does not reach the lower end portion 231B. The elastic body 233 presses the side portion 131 by coming into contact with the outer peripheral surface of the side portion 131 in a state in which the plug connector 20 is fitted to the receptacle connector 10.

The elastic body 233 may be configured to include a plurality of elastic bodies 233. The elastic bodies 233 may be provided, for example, on each of the pair of long sides and the pair of short sides of the shell 23. The elastic bodies 233 may be disposed such that two elastic bodies 233 are arranged on one side of the shell 23 in the long side direction DL1, for example.

Returning to FIGS. 5A to 5D, the plug connector 20 has the shield wall portion 24 adjacent to the shield wall portion 133 in the state in which the plug connector 20 and the receptacle connector 10 are fitted to each other. The shield wall portion 24 is configured of a thin metal member having a plate shape. The shield wall portion 24 may include two shield wall portions 24. For example, as shown in FIG. 5A, the two shield wall portions 24 are disposed in the first type holding area 221 so as to sandwich the first type contact 21A in the long side direction DL1. The shield wall portions 24 are held by the housing 22 and protrude toward the receptacle connector 10 in the connection direction CD1. The shield wall portions 24 are electrically connected to the ground conductors 203 of the board 201.

In addition, although the shield wall portions 24 are provided separately away from the shell 23 in the present example, the shield wall portions 24 may be formed integrally with the shell 23 or may be formed separately so as to be in contact with the shell 23. Furthermore, the shield wall portions 24 may be directly connected to the ground conductors 203 of the board 201 or may be connected to the ground conductors 203 of the board 201 via another portion of the shell 23.

The above configuration is merely an example and may be changed as appropriate. For example, the housing 22 may have at least one second type holding area 222 and may not necessarily have two or more second type holding areas 222. The housing 22 may be partitioned into four or more holding areas. The first type holding area 221 may not necessarily be interposed between the two second type holding areas 222, and the second type holding areas 222 may be adjacent to each other.

### Fitting State of Connector Device

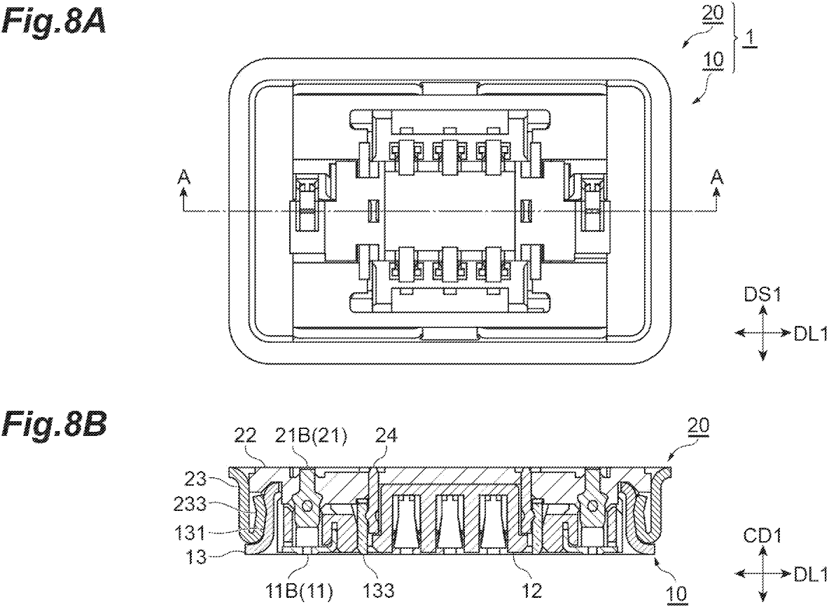

FIGS. 8A and 8B are diagrams showing the connector device 1 in the state in which the receptacle connector 10 and the plug connector 20 are fitted to each other. FIG. 8A is a plan view, and FIG. 8B is a cross-sectional view along line A-A of FIG. 8A.

As shown in FIG. 8B, the shell 23 is located on the outer periphery of the shell 13 in the state in which the plug connector 20 and the receptacle connector 10 are fitted to each other. Also, the elastic body 233 presses the side portion 131. In the connector device 1, the second type contacts 11B are in contact with the second type contact 21B sandwiched therebetween. Further, in the connector device 1, the shield wall portion 133 and the shield wall portion 24 are adjacent to each other. The shield wall portion 24 may be located between two shield wall portions 133 in the long side direction DL1. The shield wall portion 133 and the shield wall portion 24 jointly partition the first type holding areas 121 and 221 and the second type holding areas 122 and 222. The surface of the housing 12 facing the plug connector 20 may be in contact with the surface of the housing 22 facing the receptacle connector 10.

FIGS. 9A to 9C are diagrams showing the connector device 1 in the state in which the receptacle connector 10 and the plug connector 20 are fitted to each other. FIG. 9A is a plan view, FIG. 9B is a cross-sectional view along the line B-B in FIG. 9A, and FIG. 9C is a cross-sectional view showing a cross section along line C-C of FIG. 9A.

As shown in FIG. 9B, the shell 23 is located on the outer periphery of the shell 13 in the state in which the plug connector 20 and the receptacle connector 10 are fitted to each other. In the connector device 1, the first type contacts 11A are in contact with the first type contacts 21A sandwiched therebetween. The holding ridge portion 22A of the first type holding area 221 that protrudes toward the receptacle connector 10 is accommodated in the accommodation groove portion 12C of the receptacle connector 10.

As shown in FIG. 9C, the shield wall portion 24 is disposed near the center in the short side direction DS1 and extends in the connection direction CD1. In the state in which the plug connector 20 and the receptacle connector 10 are fitted to each other, the shield wall portion 24 may partition at least a portion between the first type holding area 121 and the second type holding area 122 and may also partition the first type holding area 221 and the second type holding area 222.

### Method for Manufacturing Connector

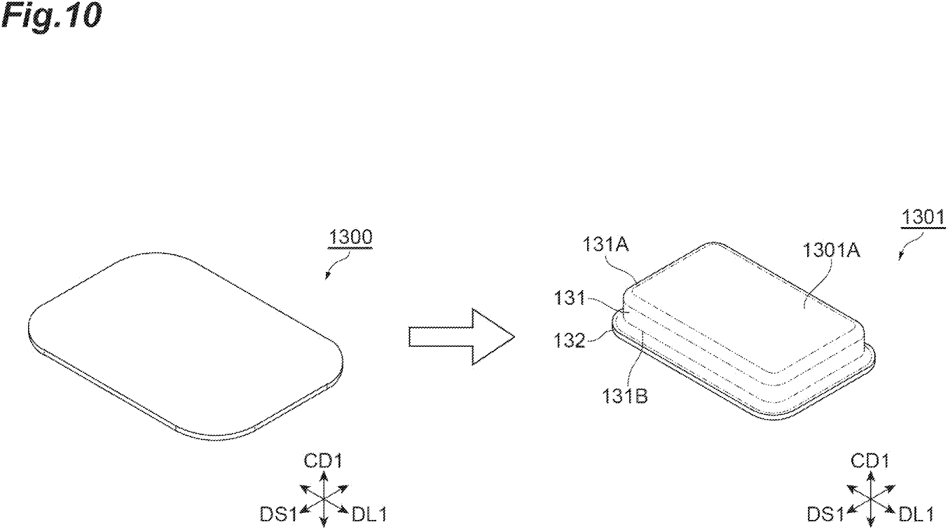

Next, a method for manufacturing a connector (the receptacle connector 10) will be described in detail. FIGS. 10 to 14 are diagrams showing manufacturing operations of the receptacle connector 10. In FIGS. 10 to 14, arrows indicate before and after states of each member in each of the manufacturing operations.

FIG. 10 is a diagram showing a first operation of the method for manufacturing the receptacle connector 10. The first operation forms a side portion 131 seamlessly formed by drawing a metal plate 1300, a ground connection portion 132 that is continuous with a lower end portion 131B that is one end of the side portion 131 and extends outwards from the side portion 131 to face the board 101, and an upper surface 1301A which is continuous with an upper end portion 131A that is the other end of the side portion 131 and which extends parallel to the ground connection portion 132. For the metal plate, a material such as stainless steel, phosphor bronze, and the like which have good workability and conductivity are selected among common metals. As for the metal plate 1300, a plurality of metal plates 1300 may be continuous in a carrier form by forming a coupling portion from either or both of the long side and the short side.

The metal plate 1300 is a thin plate having a shape that approximates a rectangle, and has a pair of long sides in the long side direction DL1 and a pair of short sides in the short side direction DS1. In the first operation, the metal plate 1300 is subjected to drawing compound (for example, rectangular tube drawing compound) to form a rectangular container-shaped shell member 1301. In such drawing compound, the side portion 131 that is a side surface portion and the ground connection portion 132 that is a flange portion in the shell member 1301 are integrally provided. Since the shell 13 is formed by drawing compound, no seams are formed on the side portion 131.

FIG. 11 is a diagram showing a second operation of the method for manufacturing the receptacle connector 10. The second operation prepares an insulating housing 12 that forms a connector and a plurality of contacts 11 assembled in the housing 12 and including one or more first type contacts 11A and one or more second type contacts 11B for transmitting high frequency signals having a higher frequency than that of signals transmitted by the first type contact 11A.

In the second operation, the first type contact 11A is accommodated in the first type contact accommodating portion 12A by press-fitting the first type contact 11A into the first type contact accommodating portion 12A in the connection direction CD1. Further, the second type contact 11B is accommodated in the second type contact accommodating portion 12B by press-fitting the second type contact 11B into the second type contact accommodating portion 12B in the connection direction CD1. For assembling the first type contact 11A into the first type contact accommodating portion 12A and the second type contact 11B into the second type contact accommodating portion 12B, insert molding may be used instead of press fitting.

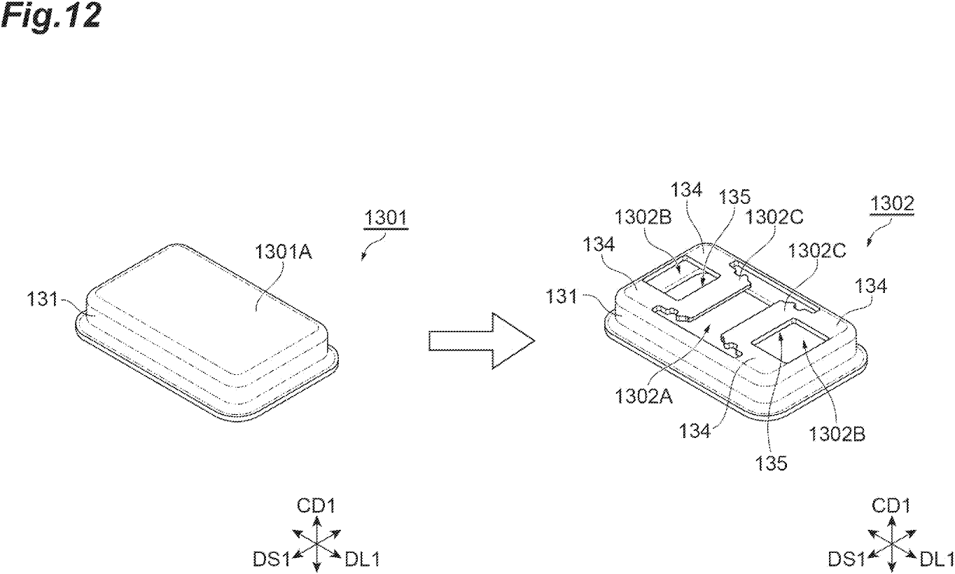

FIG. 12 is a diagram showing a third operation of the method for manufacturing the receptacle connector 10. The third operation forms a shield wall member 1302C and a coupling portion 134 that connects the side portion 131 to the shield wall member 1302C by cutting out the upper surface 1301A such that opening portions 1302A and 1302B are formed at positions corresponding to the plurality of contacts 11 when the upper surface 1301A is seen from the vertical direction.

The positions corresponding to the plurality of contacts 11 are positions at which the first type contacts 11A and the second type contacts 11B are disposed in a completed state of the receptacle connector 10. In the third operation, a shell member 1302 is formed by cutting out the upper surface 1301A such that the opening portion 1302A is formed at a position corresponding to the first type contact 11A and the opening portion 1302B is formed at a position corresponding to the second type contact 11B. The shield wall member 1302C and the coupling portion 134 that connects the side portion 131 to the shield wall member 1302C are formed by a remaining portion of the cut-out upper surface 1301A of the shell member 1302. A cutout portion 135 may be formed in the shield wall member 1302C to be continuous with the opening portion 1302B. Further, detailed shapes necessary for assembling (press-fitting) the housing 12 are also formed at this time.

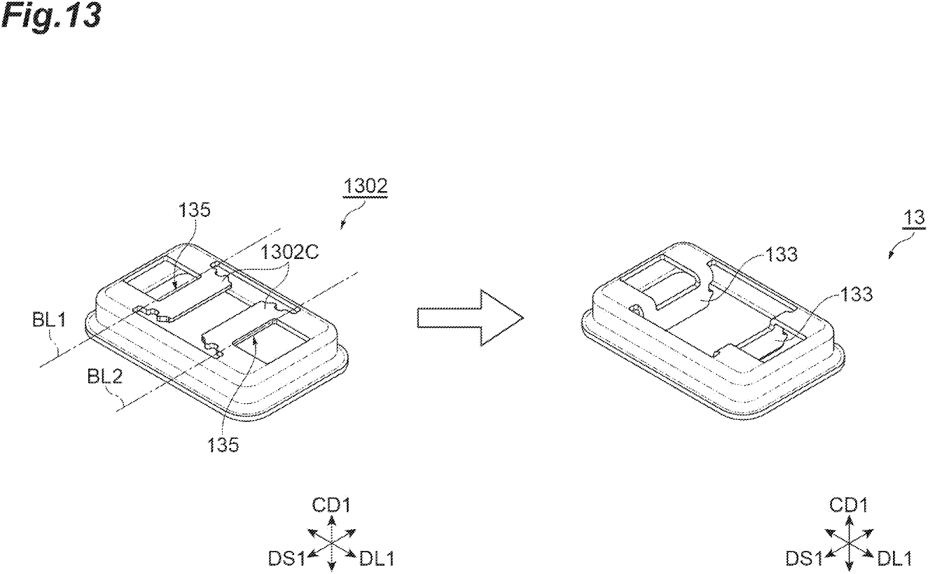

FIG. 13 is a diagram showing a fourth operation of the method for manufacturing the receptacle connector 10. In the fourth operation, a shield wall portion 133 is formed by bending the shield wall member 1302C in the fitting direction of the connector and the mating connector of the connector.

In the fourth operation, the shield wall members 1302C and 1302C are bent in the fitting direction of the connector and the mating connector along, for example, reference lines BL1 and BL2. For example, in the fourth operation, the shield wall members 1302C and 1302C are bent inwardly of the shell member 1302 in the connection direction CD1. The reference lines BL1 and BL2 may run along the cutout portions 135 and 135. Such cutout portions 135 and 135 may increase flexibility of the shield wall members 1302C and 1302C. The shield wall portion 133 is formed by bending the shield wall members 1302C and 1302C such that they are vertical. Thus, the shell 13 is manufactured. After the third operation or the fourth operation is ended, the surface of the shell 13 is plated if necessary.

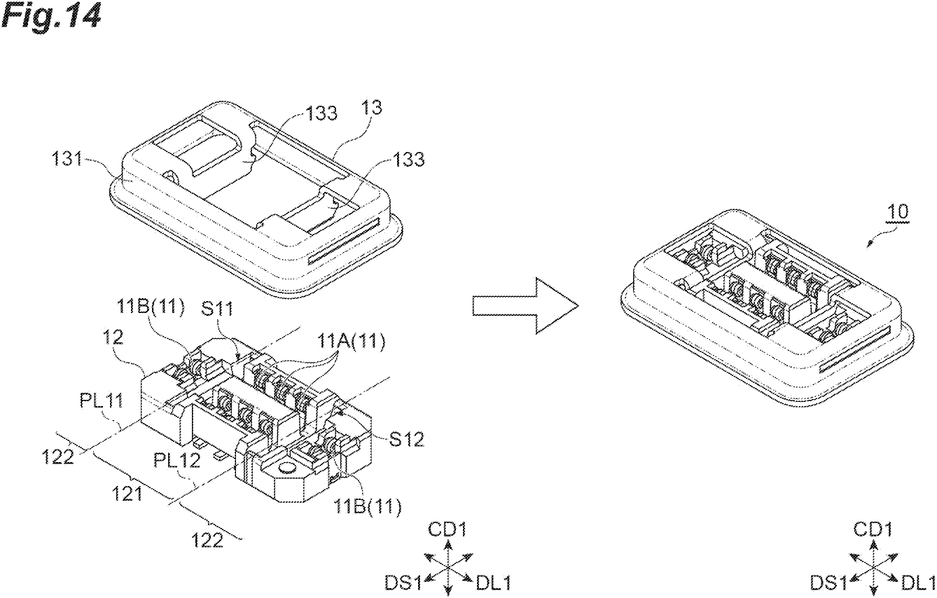

FIG. 14 is a diagram showing a fifth operation of the method for manufacturing the receptacle connector 10. In the fifth operation, the housing 12 is mounted in the shell 13 manufactured in the fourth operation, and the housing 12 is partitioned into the first type holding area 121 and the second type holding area 122 by the shield wall portion 133.

In the fifth operation, the shell 13 is mounted on the housing 12 in the connection direction CD1 such that the side portion 131 surrounds the outer periphery of the housing 12. The shield wall portion 133 is mounted so as to fill at least a part of the gap S11 formed along the boundary PL 11 and the gap S12 formed along the boundary PL 12, for example. The shield wall portion partitions the housing 12 into the first type holding area 121 and the second type holding area by mounting the shell 13 in the housing 12 in this way.

### Effects of the Present Example

The connector 10 according to one aspect of the present example is a connector 10 fitted to a mating connector 20 and includes a plurality of contacts 11 respectively connected to a plurality of conductors 102 on a board 101, an insulating housing 12 that holds the plurality of contacts 11, and a shell 13 formed by drawing compound and electrically connected to a ground conductor 103 of the board 101, wherein the plurality of contacts 11 include one or more first type contacts 11A, one or more second type contacts 11B for transmitting high frequency signals having a higher frequency than that of signals transmitted by the first type contacts 11A, and wherein the shell 13 includes a side portion 131 that seamlessly surrounds an outer periphery of the housing 12, a ground connection portion 132 that is provided integrally with the side portion 131, extends outwards from the side portion 131 and is connected to the board 101, and a shield wall portion 133 that partitions the housing 12 into a first type holding area 121 that holds the first type contacts 11A and a second type holding area 122 that holds the second type contacts 11B.

In the connector 10 according to one aspect of the present example, the shell 13 mounted on the housing 12 is formed by drawing compound. In such a shell 13, the side portion 131 that surrounds the outer periphery of the housing 12 may seamlessly surround the outer periphery of the housing 12, and also the ground connection portion 132 connected to the board 101 is formed to extend outwards from the side portion 131. According to such a configuration, since the portion from the board 101 to the side portion 131 of the shell 13 is sealed, leakage of noise from the inside of the shell 13 to the outside is curbed. Further, in the connector 10, the housing 12 is partitioned into a first type holding area 121 that holds the first type contacts 11A and a second type holding area 122 that holds the second type contacts 11B for high frequency signals by the shield wall portion 133 of the shell 13. Mutual influence of noise between the first type contact 11A and the second type contact 11B may be reduced by isolating the second type contact 11B, which tends to be a noise source and is susceptible to noise, from the first type contact 11A. With such a configuration, the EMI characteristics of the connector 10 may be improved.

A connector 20 according to one aspect of the present example is a connector 10 fitted to a mating connector 10 and includes a plurality of contacts 21 respectively connected to a plurality of conductors 202 on a board 201, an insulating housing 22 that holds the plurality of contacts 21, and a shell 23 formed by drawing compound and electrically connected to a ground conductor 203 of the board 201, wherein the plurality of contacts 21 include one or more first type contacts 21A, one or more second type contacts 21B for transmitting high frequency signals having a higher frequency than that of signals transmitted by the first type contacts 21A, and the shell 23 includes a side portion 231 that seamlessly surrounds an outer periphery of the housing 22, a ground connection portion 232 that is provided integrally with the side portion 231, extends outwards from the side portion 231 and is connected to the board 201, and a shield wall portion 24 that partitions the housing 22 into a first type holding area 221 that holds the first type contacts 21A and a second type holding area 222 that holds the second type contacts 21B.

In the connector 20 according to one aspect of the present example, the shell 23 mounted on the housing 22 is formed by drawing compound. In such a shell 23, the side portion 231 that surrounds the outer periphery of the housing 22 may seamlessly surround the outer periphery of the housing 22, and also the ground connection portion 232 connected to the board 201 is formed to extend outwards from the side portion 231. According to such a configuration, since the portion from the board 201 to the side portion 231 of the shell 23 is sealed, leakage of noise from the inside of the shell 23 to the outside is curbed. Moreover, in the connector 20, the housing 22 is partitioned into a first type holding area 221 that holds the first type contacts 21A and a second type holding area 222 that holds the second type contacts 21B for high frequency signals by the shield wall portion 24 of the shell 23. Mutual influence of noise between the first type contact 21A and the second type contact 21B may be reduced by isolating the second type contact 21B, which tends to be a noise source and is susceptible to noise, from the first type contact 21A. With such a configuration, the EMI characteristics of the connector 20 may be improved.

In the connector 10 described above, the shell 13 may further includes a coupling portion 134 that connects the side portion 131 to the shield wall portion 133. A potential difference between the respective portions may be reduced by connecting the side portion 131 and the shield wall portion 133 with the coupling portion 134, and thus the shielding characteristics may be improved. Further, due to the side portion 131 and the shield wall portion 133 being connected to each other, rigidity of the shell 13 is improved, and the number of parts is reduced, resulting in a simple configuration.

In the connector 10, the coupling portion 134 may be integrated continuously with an upper end portion 131A, which is an end portion of the side portion 131 in a direction away from the board 101, in a vertical direction that is a fitting direction of the connector 10 with the plug connector 20. The coupling portion may extend from the upper end portion 131A of the side portion 131 to connect the side portion 131 to the shield wall portion 133 integrally. Since airtightness of an upper surface of the shell 13 is improved by the coupling portion 134 extending from the upper end portion 131A of the side portion 131, that is, from the upper surface of the shell 13, leakage of noise from the upper surface of the shell 13 is curbed. Thus, the EMI characteristics of the connector 10 may be further improved.

In the connector 10 described above, the coupling portion 134 may extend from the upper end portion 131A of the side portion 131 so as to partially cover the second type holding area 122. Thus, the coupling portion 134 covers a region close to the second type contact 11B, thereby suppressing leakage of noise from the region. As a result, the EMI characteristics of the connector 10 may be further improved.

In the connector 10 described above, the side portion 131 may surrounds the outer periphery of the housing 12 so as to have a substantially quadrilateral shape when seen in the vertical direction. The coupling portions 134 may extends continuously from both of two mutually intersecting sides forming the side portion 131 at four corners of the side portion 131. According to conventional operation of a shell member, seams were formed at the four corners by bending a metal plate, but the connector 10 may be configured such that the side portion 131 surrounding the outer periphery of the housing 12 seamlessly surrounds the outer periphery of the housing 12. The airtightness at the four corners of the side portion 131 of the shell 13 is improved by providing coupling portions 134 continuously to both of the two mutually intersecting sides forming the side portion 131 at the four corners of the side portion 131, and thus leakage of noise from the four corners is curbed. In addition, since each connected member has the same potential, a noise shielding property of each member is improved. Thus, the EMI characteristics of the connector 10 may be further improved. Furthermore, the side portion 131 and the shield wall portion 133 may be easily connected by arranging the coupling portion 134 at each of the four corners of the side portion 131.

In the connector 10 described above, the coupling portion 134 may include an opening 136 for exposing the second type contact 11B. According to such a configuration, it is possible to suppress leakage of noise and to ensure contact between the contacts when the connector 10 and the mating connector 20 are fitted to each other.

In the connector 10 described above, a cutout portion 135 may be formed on the shield wall portion 133 so as facing the opening 136. According to such a configuration, when the shield wall portion 133 is formed by bending operation, easiness of bending is increased, and thus easiness of manufacturing the shell 13 is improved.

A connector device 1 according to one aspect of the present example is a connector device 1 including a plug connector 20 and a receptacle connector 10 fitted to the plug connector 20, wherein the receptacle connector 10 includes a plurality of contacts 11 respectively connected to a plurality of conductors 102 on a board 101, an insulating housing 12 that holds the plurality of contacts 11, and a shell 13 formed by drawing compound and electrically connected to a ground conductor 103 of the board 101, wherein the plurality of contacts 11 includes one or more first type contacts 11A, one or more second type contacts 11B for transmitting high frequency signals having a frequency higher than that of signals transmitted by the first type contacts 11A, wherein the shell 13 includes a side portion 131 that seamlessly surrounds an outer periphery of the housing 12, a ground connection portion 132 that is provided integrally with the side portion 131, extends outwards from the side portion 131 and is connected to the board 101, and a first (receptacle) shield wall portion 133 that partitions the housing 12 into a first type holding area 121 that holds the first type contacts 11A and a second type holding area 122 that holds the second type contacts 11B, and wherein the plug connector 20 includes a second (plug) shield wall portion 24 adjacent to the receptacle shield wall portion 133 in a state in which the plug connector 20 and the receptacle connector 10 are fitted to each other.

In the connector device 1 according to one aspect of the present example, the shell 13 mounted on the housing 12 is formed by drawing compound. In such a shell 13, the side portion 131 surrounding the outer periphery of the housing 12 may be configured to seamlessly surround the outer periphery of the housing 12, and also the ground connection portion 132 connected to the board 101 is formed to extend outwards from the side portion 131. According to such a configuration, since the portion from the board 101 to the side portion 131 of the shell 13 is sealed, leakage of noise from the inside of the shell 13 to the outside is curbed. In addition, in the connector device 1, the housing 12 is partitioned into the first type holding area 121 that holds the first type contacts 11A and the second type holding area 122 that holds the second type contacts 11B for high frequency signals by the receptacle shield wall portion 133 of the shell 13. In this way, mutual influence of noise between the first type contact 11A and the second type contact 11B may be reduced by isolating the second type contact 11B, which tends to be a noise source and is susceptible to noise, from the first type contact 11A. Furthermore, in the state in which the plug connector 20 and the receptacle connector 10 are fitted to each other, the receptacle shield wall portion 133 and the plug shield wall portion 24 jointly partition the first type holding areas 121 and 221 and the second type holding areas 122 and 222. Thus, mutual influence of noise between the first type contacts 11A and 21A and the second type contacts 11B and 21B may be reduced. As a result, the EMI characteristics of the connector device 1 may be further improved.

A method for manufacturing a connector according to one aspect of the present example includes performing drawing compound on a metal plate 1300 to form a side portion 131, a ground connection portion 132 and an upper surface 1301A seamlessly, wherein the ground connection portion 132 extends integrally from a lower end portion 131B of the side portion 131 outwards so as to face a board 101, and wherein the upper surface 1301A extends integrally from an upper end portion 131A of the side portion 131 and extends parallel to the ground connection portion 132, preparing an insulating housing 12 and a plurality of contacts 11, wherein the plurality of contacts 11 are assembled in the housing 12 and include one or more first type contacts 11A and one or more second type contacts 11B, and wherein the one or more second type contacts 11B are configured to transmit high frequency signals having a higher frequency than signals transmitted by the first type contacts 11A, cutting out the upper surface 1301A such that opening portions 1302A and 1302B are formed at positions corresponding to the plurality of contacts 11 when the upper surface 1301A is seen from a vertical direction, so as to form a shield wall member 1302C and a coupling portion 134, wherein the coupling portion 134 connects the side portion 131 to the shield wall member 1302C integrally, bending the shield wall member 1302C in a fitting direction of the connector 10 and a mating connector 20 so as to form a shield wall portion 133, wherein a shell of the connector includes the side portion 131, the ground connection portion 132, the shield wall portion 133 and the coupling portion 134, and mounting the housing 12 in the shell 13 so as to partition the housing 12 into a first type holding area 121 and a second type holding area 122 by the shield wall portion 133.

In the manufacturing method for the connector 10 according to one aspect of the present disclosure, first, the metal plate 1300 is drawn to form the side portion 131, the ground connection portion 132, and the upper surface 1301A. Second, the plurality of contacts (including the first type contacts and the second type contacts for high-frequency signals) assembled in the insulating housing are prepared. Third, when the upper surface 1301A formed by drawing compound is seen from the vertical direction, the coupling portion 134 connected to the side portion 131 and the shield wall member 1302C connected to the coupling portion 134 are formed by cutting out the upper surface 1301A such that the opening portions 1302A and 1302B are formed at positions corresponding to the plurality of contacts 11. Fourth, the shield wall portion 133 is formed by bending the shield wall member 1302C in the fitting direction of the connector 10 and the mating connector 20. The shell 13 that forms the connector 10 is manufactured by the operations so far. Fifth, when the housing 12 is mounted in the shell 13, the connector 10 in which the housing 12 is partitioned into the first type holding area 121 and the second type holding area 122 by the shield wall portion 133 is manufactured. According to such a manufacturing method, the side portion for seamlessly surrounding the outer periphery of the housing that forms the connector, the ground connection portion that is continuous with the side portion, and the upper surface are formed at once. In addition, since the coupling portion connected to the side portion and the shield wall member serving as the shield wall portion are formed by a remaining portion from which the upper surface is cut out, each member of the shell is manufactured of the same metal plate. Thus, the rigidity of the shell is improved, and the number of parts is reduced, resulting in a simple configuration. In the connector 10 manufactured by the manufacturing method, the shell 13 mounted on the housing 12 is formed by drawing compound. In such a shell 13, the side portion 131 surrounding the outer periphery of the housing 12 may seamlessly surround the outer periphery of the housing 12, and also the ground connection portion 132 connected to the board 101 is formed to extend outwards from the side portion 131. According to such a configuration, since the portion from the board 101 to the side portion 131 of the shell 13 is sealed, leakage of noise from the inside of the shell 13 to the outside is curbed. Further, in the connector 10, the housing 12 is partitioned into the first type holding area 121 that holds the first type contacts 11A and the second type holding area 122 that holds the second type contacts 11B for high-frequency signals by the shield wall portion 133 of the shell 13. In this way, mutual influence of noise between the first type contact 11A and the second type contact 11B may be reduced by isolating the second type contact 11B, which tends to be a noise source and is susceptible to noise, from the first type contact 11A. With such a configuration, the EMI characteristics of the connector 10 may be improved.

### Modified Examples

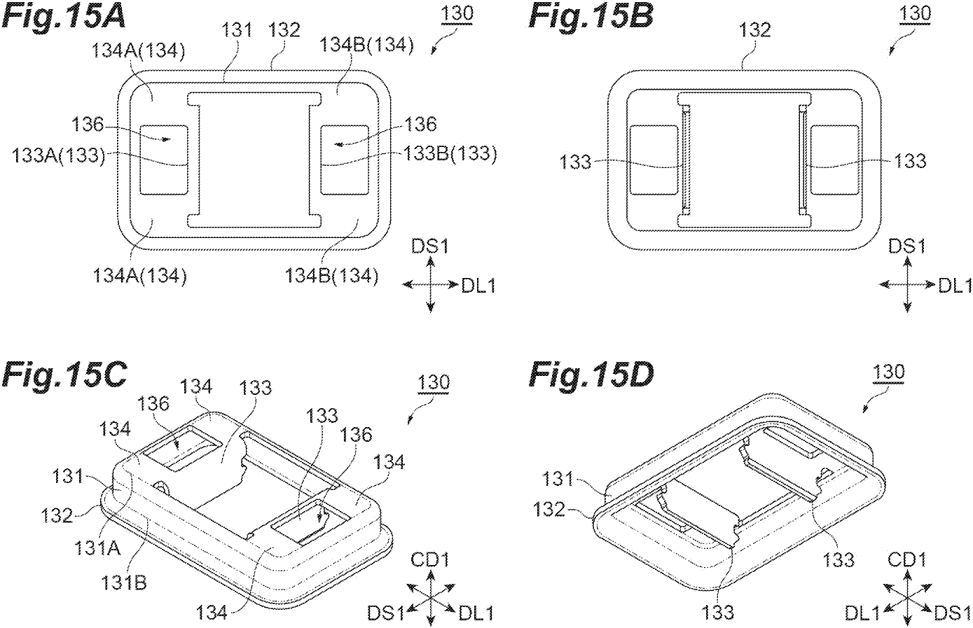

It is to be understood that not all aspects, advantages and features described herein may necessarily be achieved by, or included in, any one particular example. Indeed, having described and illustrated various examples herein, it should be apparent that other examples may be modified in arrangement and detail. For example, in the example described above, the cutout portion 135 is formed on the shield wall portion 133 and the cutout portion 135 faces the opening 136, but the cutout portion 135 may not be formed and the shield wall portion 133 faces the opening 136 directly without a cutout. FIGS. 15A to 15D shows a shell 130 of the receptacle connector 10 according to a modified example. As shown in FIGS. 15A to 15D, the shield wall portion 133 has no cutout portions. With such a configuration, since a surface area of the shield wall portion 133 may be increased, shield characteristics of the shield wall portion 133 are improved. Thus, the EMI characteristics of the receptacle connector 10 may be further improved.

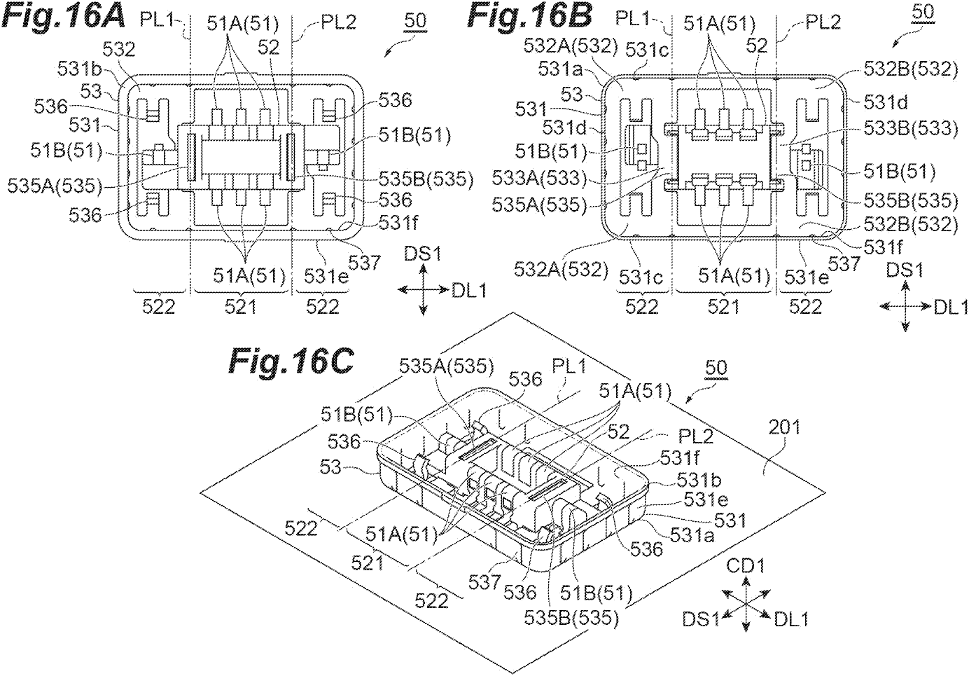

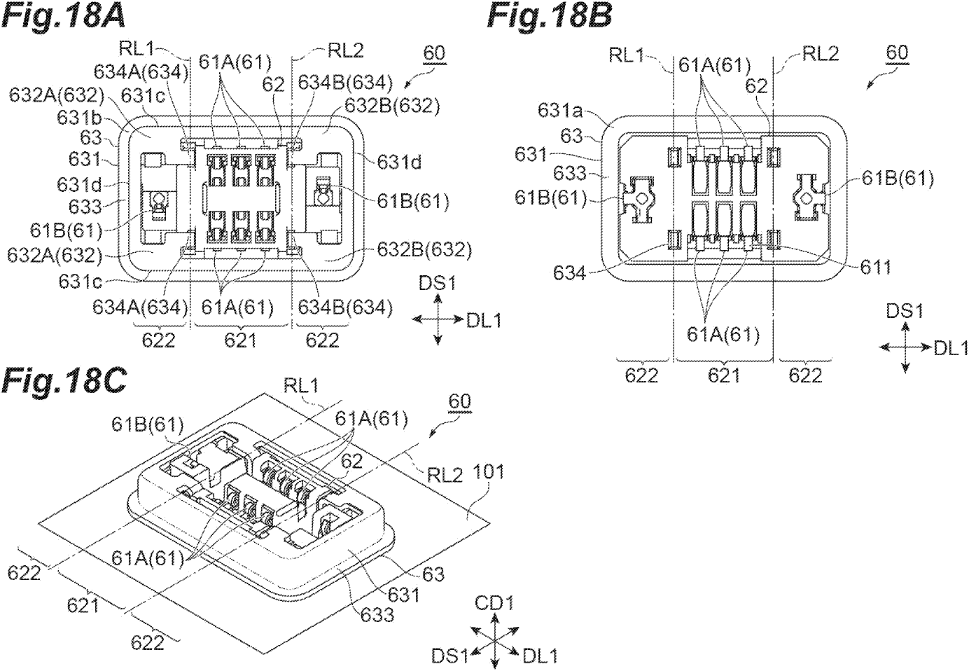

In the example described above, although the example in which the shield wall portion 133 (the receptacle shield wall portion) and the shield wall portion 24 (the plug shield wall portion) are adjacent to each other in the long side direction DL1 in the state in which the plug connector 20 and the receptacle connector 10 are fitted to each other has been described, the receptacle shield wall portion and the plug shield wall portion may be adjacent to each other in the short side direction DS1. First, a configuration of a plug connector 50 according to the modified example will be described in detail. The plug connector 50 is mounted on the board 201 and connected to a receptacle connector 60 (refer to FIG. 18A) as a mating connector. As shown in FIGS. 16A to 16C, the plug connector 50 includes plug contacts 51 (a plurality of contacts), a plug housing 52 (a housing), and a plug shell 53 (a shell). In the following, the plug connector 50 will be mainly described for the parts that are different from the plug connector 20.

The plug contact 51 has six first type contacts 51A and two second type contacts 51B, as shown in FIGS. 16A to 16C. The plug housing 52 is partitioned into a plurality of holding areas in a direction perpendicular to the connection direction CD1. The plurality of holding areas include, for example, one first type holding area 521 and two second type holding areas 522. In the following description, it is assumed that the first type holding area 521 holds the six first type contacts 51A. In the following description, each of the second type holding areas 522 holds one second type contact 51B.

The plug shell 53 shown in FIGS. 16A to 16C is a conductive member electrically connected to the ground conductor 203 of the board 201 by soldering or the like. The plug shell 53 surrounds a region of approximately rectangular outline when seen from the receptacle connector 60. The plug shell 53 is disposed to surround the outer periphery of the plug housing 52. The plug shell 53 has a side portion 531 and a bottom portion 532. The plug shell 53 is integrally provided with the side portion 531 that is a side surface portion and the bottom portion 532 as a bottom surface portion in a rectangular container-shaped member formed by performing drawing compound (for example, rectangular tube drawing compound) on a metal plate. Since the plug shell 53 is formed by drawing compound, no seams are formed on the side portion 531.

The side portion 531 surrounds the outer periphery of the plug housing 52 to have a substantially rectangular shape when seen from the receptacle connector 60. The plug contact 51 is disposed within a region surrounded by the side portion 531. The side portion 531 has a pair of side wall portions 531c and 531c in a longitudinal direction (the long side direction DL1) of the outer periphery of the plug housing 52, and a pair of end wall portions 531d and 531d that are continuous with the side wall portion 531c and follows a direction (the short side direction DS1) perpendicular to the longitudinal direction of the outer periphery of the plug housing 52 (refer to FIG. 16B).

The side portion 531 may have a protruding portion 537 that protrudes inward from an inner peripheral surface 531f. The protruding portion 537 is formed, for example, by performing dimple operation or the like from an outer peripheral surface 531e of the side portion 531 toward the inner peripheral surface 531f. The protruding portion 537 may include a plurality of protruding portions 537. For example, the protruding portion 537 may be formed on each of the side wall portion 531c and the end wall portion 531d. The protruding portion 537 presses a side portion 631 (refer to FIGS. 18A to 18C) of the receptacle connector 60 in the state in which the plug connector 50 and the receptacle connector 60 are fitted to each other.

The bottom portion 532 is continuous with an end portion 531a of the side portion 531 in a direction toward the board 201 and extends along the board 201 into a region surrounded by the side portion 531. The bottom portion 532 is provided at four corners of the side portion 531 when seen from the receptacle connector 60 to be continuous with two sides (that is, the side wall portion 531c and the end wall portion 531d) that form the side portion 531 and intersect each other. The bottom portion 532 covers a part of board 201 when seen from receptacle connector 60.

The bottom portion 532 is electrically connected to a ground conductor 203 of board 201. The bottom portion 532 may be directly connected to the ground conductor 203 of board 201 or may be connected to the ground conductor 203 of board 201 via another portion of plug shell 53. Hereinafter, it is assumed that the bottom portion 532 is directly connected to the ground conductor 203 of the board 201.

The bottom portion 532 has bottom portions 532A and 532B, a coupling portion 533 and an engaging portion 536. As shown in FIG. 16B, the bottom portion 532A and the bottom portion 532B are provided to correspond to the two second type holding areas 522, respectively. The bottom portion 532A has a portion (a first corner portion) that is continuous with both an end portion 531a of one side wall portion 531c in the direction toward the board 201 and an end portion 531a of one end wall portion 531d, and a portion (a second corner portion) that is continuous with both an end portion 531a of the other side wall portion 531c and an end portion 531a of one end wall portion 531d. Further, the bottom portion 532B has a portion (a third corner portion) that is continuous with both an end portion 531a of one side wall portion 531c and an end portion 531a of the other end wall portion 531d, and a portion (a fourth corner portion) that is continuous with both an end portion 531a of the other side wall portion 531c and an end portion 531a of the other end wall portion 531d.

The coupling portion 533 connects the pair of side wall portions 531c and 531c to each other. For example, the coupling portion 533 has coupling portions 533A and 533B that are respectively provided to correspond to the two second type holding areas 522. The coupling portion 533A connects the pair of side wall portions 531c and 531c to each other by connecting the first corner portion of the bottom portion 532A to the second corner portion of the bottom portion 532A in the short side direction DS1. The coupling portion 533B connects the pair of side wall portions 531c and 531c to each other by connecting the third corner portion of the bottom portion 532A to the fourth corner portion of the bottom portion 532A in the short side direction DS1.

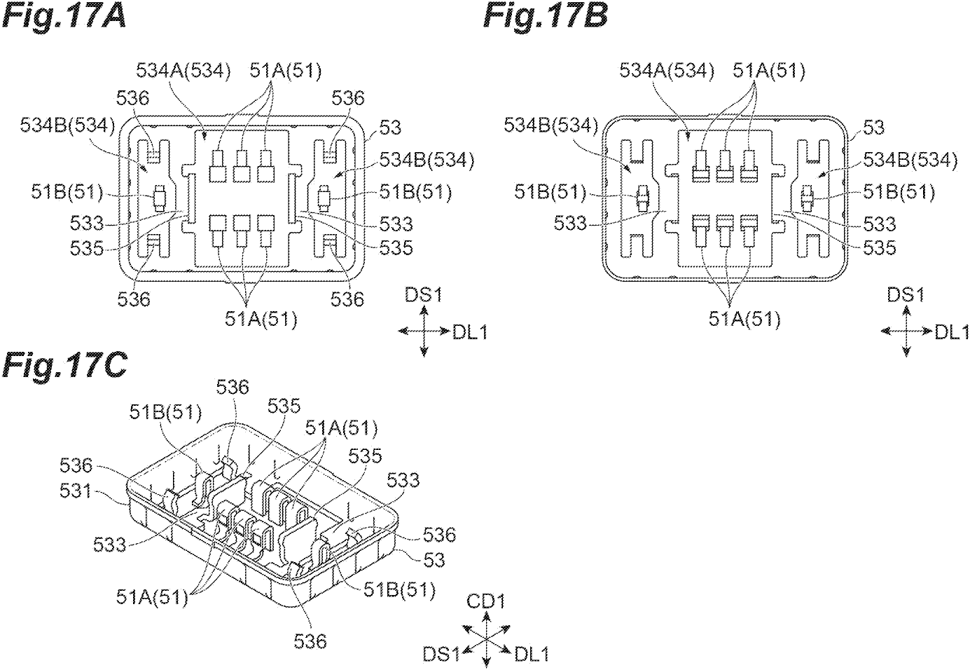

Further, the coupling portion 533 is provided along the board 201 to divide a region in which the first type contacts 51A are disposed and a region in which the second type contacts 51B are disposed. As shown in FIGS. 17A and 17B, the plug shell 53 has an opening 534 formed therein. The opening 534 is formed, for example, by cutting out a bottom portion of a rectangular container-shaped member formed by drawing compound. For example, two openings 534B that respectively surrounds regions in which two second type contacts 51B are disposed are formed at both ends of the plug shell 53 in the long side direction DL1. Also, one opening 534A that surrounds the region in which the six first type contacts 51A are disposed is formed in the plug shell 53. The coupling portion 533 is formed between the opening 534A and one opening 534B by a remaining portion due to the cutting-out. The coupling portion 533 is formed between the opening 534A and the other opening 534B by a remaining portion due to the cutting-out. Such a coupling portion 533 divides a region (the opening 534A) in which the first type contact 51A is disposed and a region (the opening 534B) in which the second type contact 51B is disposed.

As shown in FIGS. 17A to 17C, the coupling portion 533 has a partition wall portion 535 (the plug shield wall portion) that stands upright in a direction (the connection direction CD1) away from the board 201. A length of the partition wall portion 535 in the short side direction DS1 is shorter than a length of a region of the coupling portion 533 in the short side direction DS1 other than the partition wall portion 535. As shown in FIGS. 16A to 16C, the partition wall portion 535 partitions the plug housing 52 into a first type holding area 521 that holds the first type contacts 51A and a second type holding area 522 that holds the second type contacts 51B. For example, the partition wall portion 535 includes a partition wall portion 535A and a partition wall portion 535B. The partition wall portion 535A is provided at a position (the boundary PL1) that partitions the second type holding area 522 and the first type holding area 521 in the plug housing 52. The partition wall portion 535B is provided at a position (the boundary PL2) that partitions the second type holding area 522 and the first type holding area 521 in the plug housing 52.

The engaging portion 536 protrudes in a direction away from the board 201. The engaging portion 536 is connected to the ground conductor 203 of the board 201. The engaging portion 536 engages with an engaged portion 635 (refer to FIG. 5A) of the receptacle connector 60. For example, the engaging portion 536 is formed as an S-shaped leaf spring that extends in the connection direction CD1. A pair of engaging portions 536 are provided, for example, to sandwich the second type contacts 51B in the short side direction DS1. That is, a pair of contact points with the ground conductors 203 of the board 201 by the engaging portion 536 are provided to sandwich the second type contacts 51B.

Each member of the plug shell 53 formed in this way is electrically connected. The ground conductor 203 of board 201 may be formed in a substantially circumferential shape to surround a plurality of conductors 203 equally formed on board 201. Thus, after the plug connector 50 is mounted, the shielding performance of the entire board 201 may be further improved.

Next, a configuration of the receptacle connector 60 according to the modified example will be described in detail. The receptacle connector 60 is mounted on the board 101 and connected to the plug connector 50 as a mating connector. As shown in FIGS. 18A to 18C, the receptacle connector 60 has receptacle contacts 61 (the plurality of contacts), a receptacle housing 62 (the housing), and a receptacle shell 63 (the shell). The parts different from those of the receptacle connector 10 are mainly described below.

The receptacle contact 61 has six first type contacts 61A and two second type contacts 61B, as shown in FIGS. 18A to 18C. The receptacle housing 62 is partitioned into a plurality of holding areas in the direction perpendicular to the connection direction CD1. The plurality of holding areas are configured to include, for example, one first type holding area 661 and two second type holding areas 622. In the following description, it is assumed that the first type holding area 621 holds the six first type contacts 61A. In the following description, each of the second type holding areas 622 holds one second type contact 61B.

The receptacle shell 63 shown in FIGS. 18A to 18C is a conductive member electrically connected to the ground conductor 103 of the board 101 by soldering or the like. The receptacle shell 63 surrounds a region of approximately rectangular outline when seen from the plug connector 50. The receptacle shell 63 is mounted on the receptacle housing 62 to surround the receptacle housing 62. The receptacle shell 63 has a side portion 631, an upper portion 632 and a ground connection portion 633. The receptacle shell 63 is integrally provided with the side portion 631 that is a side surface portion, the upper portion 632 that is an upper surface portion, and the ground connection portion 633 that is a flange portion in a rectangular container-shaped member formed by performing drawing compound (for example, rectangular tube drawing compound) on a metal plate. Since the receptacle shell 63 is formed by drawing compound, no seams are formed on the side portion 631.

The side portion 631 surrounds the outer periphery of the receptacle housing 62 to have a substantially quadrilateral shape when seen from the plug connector 50. The receptacle contacts 61 are disposed within a region surrounded by the side portion 631. Further, the side portion 631 has a pair of side wall portions 631c and 631c in the longitudinal direction (the long side direction DL1) of the outer periphery of the receptacle housing 62, and a pair of end wall portions 631d and 631d that are continuous with the side wall portion 631c and follows a direction (the short side direction DS1) perpendicular to the longitudinal direction of the outer periphery of the receptacle housing 62 (refer to FIG. 18A).

The upper portion 632 is continuous with the end portion 631b of the side portion 631 in the direction away from the board 101 and extends within the region surrounded by the side portion 631. The upper portion 632 is provided continuously on both of two mutually intersecting sides forming the side portion 631 at the four corners of the side portion 631 when seen from the plug connector 50. As seen from receptacle connector 60, the upper portion 632 covers a part of second type holding area 622.

As shown in FIG. 18A, the upper portion 632 includes upper portions 632A and 632B provided to correspond to the two second type holding areas 522, respectively. The upper portion 632A has a portion (a first corner portion) that is continuous with both the end portion 631b of one side wall portion 631c in the direction away from the board 101 and the end portion 631b of one end wall portion 631d, and a portion (a second corner portion) that is continuous with both the end portion 631b of the other side wall portion 631c and the end portion 631b of the one end wall portion 631d. Further, the upper portion 632B has a portion (a third corner portion) that is continuous with both the end portion 631b of one side wall portion 631c and the end portion 631b of the other end wall portion 631d, and a portion (a fourth corner portion) that is continuous with both the end portion 631b of the other side wall portion 631c and the end portion 631b of the other end wall portion 631d.

The ground connection portion 633 is provided to be continuous with the end portion 631a of the side portion 631 in the direction toward the board 101 and extends outwards from the side portion 631. The ground connection portion 633 is connected to the ground conductor 103 of the board 101 by soldering or the like. Thus, the receptacle shell 63 is sealed from the board 101 to the side portion 631. The ground connection portion 633 may be directly connected to the ground conductor 103 of the board 101 or may be connected to the ground conductor 103 of the board 101 via another portion of the receptacle shell 63. In the following description, it is assumed that the ground connection portion 633 is directly connected to the ground conductor 103 of the board 101.

The upper portion 632 has a locking portion 634 (a receptacle shield wall portion) that extends toward the board 101 in the connection direction CD1. The upper portion 632 corresponds to the coupling portion 134 in the above-described example. The locking portion 634 is formed integrally with the upper portion 632 by, for example, performing bending operation on a metal plate for forming the upper portion 632. The locking portion 634 is fixed to a locking hole of the receptacle housing 62 (refer to FIG. 18B).

the locking portion 634 is electrically connected to the ground conductor 103 of board 101. The locking portion 634 may be directly connected to the ground conductor 103 of the board 101 or may be connected to the ground conductor 103 of the board 101 via another portion of the receptacle shell 63. In the following description, it is assumed that the locking portion 634A is directly connected to the ground conductor 103 of the board 101.

The locking portion 634 partitions a region in which the first type contacts 21A are disposed and a region in which the second type contacts 21B are disposed. The locking portion 634 includes, for example, a locking portion 634A that is continuous with the upper portion 632A and a locking portion 634B that is continuous with the upper portion 632B. A pair of locking portions 634A are provided near both ends in the short side direction DS1 at positions (on the boundary RL1) at which the second type holding area 622 and the first type holding area 621 are partitioned in the receptacle housing 62. A pair of locking portions 634B are provided near both ends in the short side direction DS1 at positions (on the boundary RL2) at which the other second type holding area 622 and the first type holding area 621 are partitioned in the receptacle housing 62.

In a state in which a board 201 and a board 101 on which the plug connector 50 and the receptacle connector 60 are respectively mounted face each other with a certain distance and are fitted to each other, the boundary PL1 and the boundary RL1 overlap, and the boundary PL2 and the boundary RL2 overlap. A partition wall portion 535A is disposed between a pair of locking portions 634A provided in the short side direction DS1 on the boundaries PL1 and RL1. A partition wall portion 535B is disposed between a pair of locking portions 634B provided in the short side direction DS1 on the boundaries PL2 and RL2. In other words, the locking portion 634A on one side, the partition wall portion 535A, and the locking portion 634A on the other side are disposed on the boundaries PL1 and RL1 in this order in the short side direction DS1. Moreover, the locking portion 634B on one side, the partition wall portion 535B, and the locking portion 634B on the other side are disposed on the boundaries PL2 and RL2 in this order in the short side direction DS1. That is, the locking portion 634 is disposed adjacent to the partition wall portion 535 in the short side direction DS1. In the state in which the plug connector 50 and the receptacle connector 60 are fitted to each other, the partition wall portion 535 and the locking portion 634 partition the first type holding areas 521 and 621 that hold the first type contacts 51A and 61A, respectively, and the second type holding areas 522 and 622 that hold the second type contacts 51B and 61B, respectively.

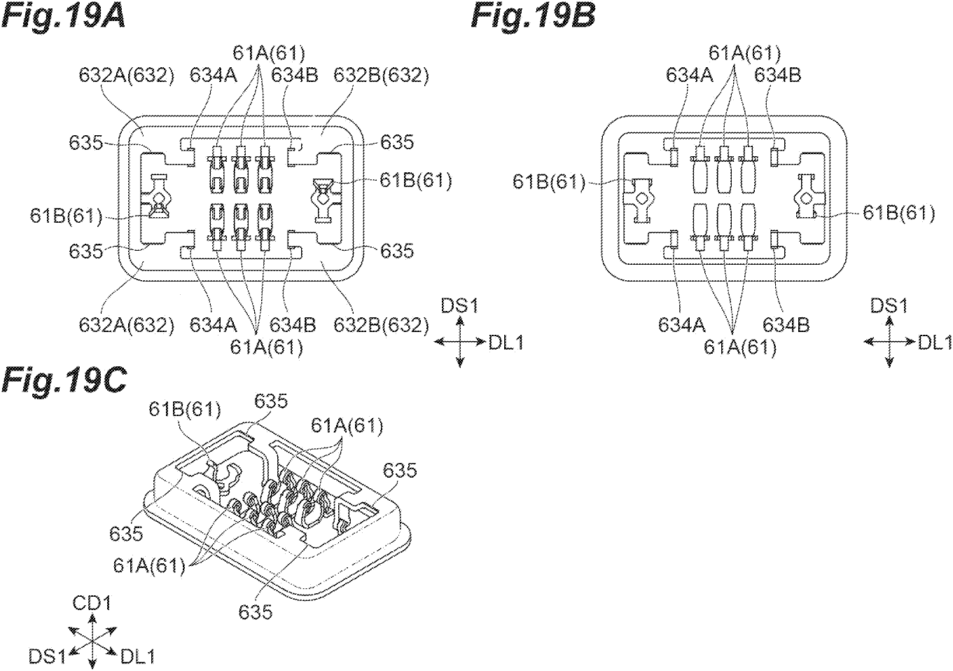

As shown in FIG. 19A, the upper portion 632 has an engaged portion 635. The engaged portion 635 is formed, for example, by cutting out a part of the upper portion 632 in the short side direction DS1. The engaged portion 635 is engaged with the engaging portion 536 in the state in which the plug connector 50 and the receptacle connector 60 are fitted to each other. For example, the engaging portion 536 is formed as an S-shaped leaf spring that extends in the connection direction CD1. Here, when the plug connector 50 and the receptacle connector 60 are fitted to each other, the engaged portion 635 comes into contact with an S-shaped bulging portion of the engaging portion 536. In this state, when a force is applied from the engaged portion 635 to the engaging portion 536 in the connection direction CD1, the engaging portion 536 is elastically deformed to be released from the engaged portion 635. In other words, the engaging portion 536 is inclined from the connection direction CD1. Further, when a force is applied from the engaged portion 635 to the engaging portion 536 in the connection direction CD1, the engaging portion 536 receives the engaged portion 635 in an S-shaped recessed portion. Then, since the force from the engaged portion 635 to the engaging portion 536 is weakened, the engaging portion 536 is subjected to a restoring force from the deformed state. In this way, the engaged portion 635 is engaged with the engaging portion 536.

Each member of the receptacle shell 63 formed in this way is electrically connected. The ground conductor 103 of the board 101 may be formed in a substantially circumferential shape to surround a plurality of conductors 102 equally formed on board 101. Thus, after the receptacle connector 60 is mounted, the shielding performance of the entire board 101 may be further improved.

1. A connector fitted to a mating connector, comprising:
a plurality of contacts respectively connected to a plurality of conductors of a board;
an insulating housing holding the plurality of contacts; and
a shell formed by drawing compound and electrically connected to a ground conductor of the board,
wherein the plurality of contacts comprise:
one or more first type contacts; and
one or more second type contacts for transmitting high frequency signals having a higher frequency than signals transmitted by the first type contacts, and
wherein the shell comprises:
a side portion that seamlessly surrounds an outer periphery of the housing;
a ground connection portion that is integrally provided with the side portion and extends outwards from the side portion to be connected to the board; and
a shield wall portion that partitions the housing into a first type holding area that holds the first type contacts and a second type holding area that holds the second type contacts.

2. The connector according to claim 1, wherein the shell further comprises a coupling portion that connects the side portion to the shield wall portion.

3. The connector according to claim 2,
wherein the coupling portion is integrated continuously with an upper end portion, which is an end portion of the side portion in a direction away from the board, in a vertical direction which is a fitting direction of the connector with the mating connector, and
wherein the coupling portion extends from the upper end portion of the side portion to connect the side portion to the shield wall portion integrally.

4. The connector according to claim 3, wherein the coupling portion extends from the upper end portion of the side portion to cover a part of the second type holding area.

5. The connector according to claim 3,
wherein the side portion has a substantially quadrilateral shape when seen in the vertical direction so as to surround the outer periphery of the housing, and
wherein the coupling portion extends continuously from both of two mutually intersecting sides that form the side portion at four corners of the side portion.

6. The connector according to claim 4, wherein the coupling portion comprises an opening for exposing the second type contacts.

7. The connector according to claim 6, wherein a cutout portion is formed on the shield wall portion facing the opening.

8. The connector according to claim 6, wherein the shield wall portion faces the opening directly without a cutout.

9. The connector according to claim 1, wherein the shield wall portion extends in a planar shape.

10. The connector according to claim 1, wherein the ground connection portion surrounds the side portion and extends outwards from the side portion integrally.

11. The connector according to claim 1, wherein the shell is formed by rectangular tube drawing compound so as that the shell comprises the side portion and the ground connection portion integrally.

12. The connector according to claim 1, wherein the shell is sealed from the board to the side portion.

13. The connector according to claim 1, wherein the plurality of conductors are surrounded by the ground conductor in a substantially circumferential shape.

14. The connector according to claim 3, wherein the shield wall portion comprises a first shield wall portion and a second shield wall portion.

15. The connector according to claim 14,
wherein the housing is partitioned into the first type holding area, a first second type holding area and a second second type holding area, and the first type holding area is sandwiched between the first second type holding area and the second second type holding area,
wherein the first shield wall portion partitions the first second type holding area and the first type holding area in the housing, and
wherein the second shield wall portion partitions the second second type holding area and the first type holding area in the housing.

16. The connector according to claim 14,
wherein the first shield wall portion and the second shield wall portion extend in the vertical direction,
wherein a top end potion of the first shield wall portion and a top end potion of the second shield wall portion are integrated continuously with the coupling portion, and
wherein a bottom end potion of the first shield wall portion and a bottom end potion of the second shield wall portion are connected to the ground conductor.

17. The connector according to claim 3, wherein the coupling portion comprises a first coupling portion and a second coupling portion.

18. The connector according to claim 17, wherein a first coupling portion and a second coupling portion extend parallel to the board.

19. A connector device comprising a plug connector and a receptacle connector fitted to the plug connector,
wherein the receptacle connector comprises:
a plurality of contacts respectively connected to a plurality of conductors of a board;
an insulating housing holding the plurality of contacts, and
a shell formed by drawing compound and electrically connected to a ground conductor of the board,
wherein the plurality of contacts comprise:
one or more first type contacts; and
one or more second type contacts for transmitting high frequency signals having a higher frequency than signals transmitted by the first type contacts,
wherein the shell comprises:
a side portion that seamlessly surrounds an outer periphery of the housing;
a ground connection portion that is integrally provided with the side portion and extends outwards from the side portion to be connected to the board; and
a receptacle shield wall portion that partitions the housing into a first type holding area that holds the first type contacts and a second type holding area that holds the second type contacts, and
wherein the plug connector comprises a conductive plug shield wall portion adjacent to the receptacle shield wall portion in a state in which the plug connector and the receptacle connector are fitted to each other.

20. A method for manufacturing a connector, comprising:
performing drawing compound on a metal plate to form a side portion, a ground connection portion and an upper surface seamlessly, wherein the ground connection portion extends integrally from a lower end portion of the side portion outwards so as to face a board, and wherein the upper surface extends integrally from an upper end portion of the side portion and extends parallel to the ground connection portion;
preparing an insulating housing and a plurality of contacts, wherein the plurality of contacts are assembled in the housing and comprise one or more first type contacts and one or more second type contacts, and wherein the one or more second type contacts are configured to transmit high frequency signals having a higher frequency than signals transmitted by the first type contacts;
cutting out the upper surface such that opening portions are formed at positions corresponding to the plurality of contacts when the upper surface is seen from a vertical direction, so as to form a shield wall member and a coupling portion, wherein the coupling portion connects the side portion to the shield wall member integrally;
bending the shield wall member in a fitting direction of the connector and a mating connector so as to form a shield wall portion, wherein a shell of the connector comprises the side portion, the ground connection portion, the shield wall portion and the coupling portion; and
mounting the housing in the shell so as to partition the housing into a first type holding area and a second type holding area by the shield wall portion.
